(19) United States
(12) Patent Application Publication
(10) Pub. No.: US 2023/0338892 A1
(43) Pub. Date: Oct. 26, 2023

(54) PORTABLE ATMOSPHERIC WATER GENERATOR

(71) Applicant: Spout Ventures Inc., West Hollywood, CA (US)

(72) Inventors: Reuben Paul Vollmer, II, Venice, CA (US); Tyler Breton, Los Angeles, CA (US)

(21) Appl. No.: 18/305,234

(22) Filed: Apr. 21, 2023

Related U.S. Application Data
(60) Provisional application No. 63/333,467, filed on Apr. 21, 2022.

(51) Int. Cl. B01D 53/26; B01D 53/04; C02F 1/32; B01D 46/44; C02F 1/00; C02F 1/68; B01D 46/00

(52) U.S. Cl. CPC B01D 53/261; B01D 53/0438; C02F 1/325; B01D 46/44; C02F 1/003; C02F 1/68; B01D 46/0086; B01D 2257/80; C02F 2209/42; C02F 2201/006; C02F 2209/008; C02F 2307/04; C02F 2209/445; B01D 2259/40088

(57) ABSTRACT

Provided are systems for atmospheric water generation, comprising a dehumidifier configured to receive air, comprising a desiccant core, a heater configured to heat at least a portion of the desiccant core, and a condenser system configured to collect water from the desiccant core when the desiccant core is heated by the heater; and a fluid filter configured to filter one or both of the air, prior to the air dehumidifier receiving the air, or the water, after the water is collected by the condenser system.

### CROSS REFERENCE

This application claims the benefit of U.S. provisional application 63/333,467, filed on Apr. 21, 2022, the entirety of which is hereby incorporated by reference herein.

### SUMMARY

Provided herein are embodiments of a system for atmospheric water generation comprising: an atmospheric water generator comprising: an air filter; a dehumidifying unit comprising: a desiccant core; a heater directed at a portion of the desiccant core; a condenser system to collect moisture from an airstream exhausted by the portion of the desiccant core which is heated; and a first collection tank for collecting water from the condenser; a first pump in fluid connection with the first collection tank; a first water filtration system in fluid connection with the first pump; and a potable water outflow in fluid connection with the first water filtration system.

One aspect of the present disclosure provides a system for atmospheric water generation, including: (A) a dehumidifier configured to receive air, including: (i) a desiccant core, (ii) a heater configured to heat at least a portion of the desiccant core, and (iii) a condenser system configured to collect water from the desiccant core when the desiccant core is heated by the heater; and (B) a fluid filter configured to filter one or both of (i) the air, prior to the air dehumidifier receiving the air, or (ii) the water, after the water is collected by the condenser system.

In some embodiments, the system further comprises a pitcher configured to hold the water. In some embodiments, the pitcher comprises an ultraviolet (UV) light. In some embodiments, the UV light is configured to cycle between a powered-on state and a powered-off state at a first frequency. In some embodiments, the first frequency is between 5 minutes and 120 minutes. In some embodiments, the powered-on state is configured to last for a first amount of time. In some embodiments, the first amount of time is between 3 seconds and 30 seconds. In some embodiments, the UV light is configured to direct ultraviolet-C (UV-C) light towards the water in the pitcher. In some embodiments, the system further comprises a UV-C light sensor and an alarm, wherein the alarm is configured to generate an alert when the UV light is detected by the UV-C light sensor to have degraded performance. In some embodiments, the pitcher is removable from a pitcher cavity that is physically coupled to the dehumidifier and the fluid filter. In some embodiments, the system further comprises one or more sensors configured to determine whether the pitcher is present in the pitcher cavity. In some embodiments, the one or more sensors comprise Hall effect sensors and the pitcher comprises one or more magnets configured to be aligned with the Hall effect sensors when the pitcher is present in the pitcher cavity. In some embodiments, the one or more sensors comprise an infrared distance sensor. In some embodiments, the UV light in the pitcher charges via inductive charging. In some embodiments, the system further comprises one or more sensors configured to determine a water level or a water amount in the pitcher, and wherein one or both of the dehumidifier or the fluid filter are configured to disable in response to the water level or the water amount in the pitcher satisfying a threshold. In some embodiments, the one or more sensors comprise one or more of: a capacitive water sensor, a laser distance meter, an ultrasonic distance meter, a float sensor, or a top-down ultrasound. In some embodiments, the pitcher further comprises a valve configured to regulate flow of the water for one or both of inflow or outflow from the pitcher, wherein the valve is configured to open when the pitcher is tilted. In some embodiments, the condenser system comprises a first collection tank configured to collect the water from the desiccant core when the desiccant core is heated by the heater. In some embodiments, the system further comprises a first pump in fluid connection with the first collection tank. In some embodiments, the first pump is configured to pump the water from the first fluid collection tank into a pitcher via a water outflow. In some embodiments, the system further comprises one or more sensors configured to determine a water level or a water amount in the first collection tank. In some embodiments, the first pump is configured to pump the water from the first fluid collection tank into the pitcher when the water level or the water amount in the first collection tank satisfies a threshold. In some embodiments, one or both of the dehumidifier or the fluid filter are configured to disable in response to the water level or the water amount in the first collection tank satisfying a threshold. In some embodiments, the fluid filter comprises an air filter configured to filter the air and a water filter configured to filter the water. In some embodiments, the air filter is removable from the fluid filter. In some embodiments, the air filter comprises a carbon felt filter. In some embodiments, the system further comprises an air quality sensor configured to monitor air quality of the air at one or both of a time (i) before the air is filtered by the air filter, or (ii) after the air is filtered by the air filter. In some embodiments, the system further comprises an alarm configured to indicate whether the air quality of the air satisfies a threshold. In some embodiments, the air filter comprises a radio-frequency identification (RFID) tag. In some embodiments, the system further comprises one or more sensors configured to detect, via the RFID tag, whether the air filter is present in the fluid filter. In some embodiments, the system further comprises one or more sensors configured to detect, via the RFID tag, a length of time that the air filter has been present in the fluid filter. In some embodiments, the system further comprises an alarm that is configured to generate an alert in response to the length of time satisfying a threshold. In some embodiments, one or both of the dehumidifier or the fluid filter are configured to disable in response to the length of time satisfying a threshold. In some embodiments, the water filter comprises a filter cartridge that is removable from the fluid filter. In some embodiments, the filter cartridge is configured to perform a two-stage filtration process, and wherein the filter cartridge comprises a first filter and a second filter that is in fluid connection to the first filter. In some embodiments, the first filter is configured to perform particle filtration of the water and the second filter is configured to perform remineralization of the water after the water is filtered by the first filter. In some embodiments, the first filter comprises an electropositive filter membrane. In some embodiments, the second filter adds one or more minerals to the water. In some embodiments, the one or more minerals comprise one or more of: magnesium, carbon, sodium, potassium, manganese, or iron. In some embodiments, the second filter comprises an alkaline filter. In some embodiments, the filter cartridge comprises a radio-frequency identification (RFID) tag. In some embodiments, the system further comprises one or more sensors configured to detect, via the RFID tag, whether the filter cartridge is present in the fluid filter. In some embodiments, the system further comprises one or more sensors configured to detect, via the RFID tag, a length of time that the filter cartridge has been present in the fluid filter. In some embodiments, the system further comprises an alarm that is configured to generate an alert in response to the length of time satisfying a threshold. In some embodiments, one or both of the dehumidifier or the fluid filter are configured to disable in response to the length of time satisfying a threshold. In some embodiments, the condenser system comprises one or more tube condensers. In some embodiments, the one or more tube condensers comprises plastic, ceramic, glass, or metal. In some embodiments, the metal comprises gold-plated copper. In some embodiments, the desiccant core comprises one or more of: silica, activated charcoal, calcium sulfate, calcium chloride, activated alumina, zeolites, molecular sieves, or metal organic framework (MOF). In some embodiments, the system further comprises a computing device and a wireless network interface, wherein the computing device is configured to obtain operation data. In some embodiments, the operation data comprises one or more of: a volume of the water generated by the dehumidifier over an elapsed time, a total volume of the water generated by the dehumidifier, a total operation time of the dehumidifier, temperature of the air, or humidity of the air. In some embodiments, the wireless network interface is configured to wirelessly connect to a display device that comprises a display that presents the operation data. In some embodiments, the display device is configured to transmit instructions to the wireless network interface, wherein the instructions comprise an instruction to operate one or both of dehumidifier or the fluid filter until one or more parameters are satisfied. In some embodiments, the one or more parameters comprise one or more of: a specified volume of water to be produced, a specified humidity level, a time of day, a power grid demand, or an auto-fill level. In some embodiments, the computing device is a smartphone. In some embodiments, the system further comprises a user control configured to set a power setting of one or both of the dehumidifier or the fluid filter. In some embodiments, the user control comprises a capacitive touch sensor. In some embodiments, the power setting comprises a first power level and a second power level, wherein the first power level and the second power level each correspond to a different operational rate for one or both of the dehumidifier or the fluid filter. In some embodiments, the system further comprises a spout configured to output the water. In some embodiments, the system further comprises a water chiller configured to cool the water. In some embodiments, the system further comprises a water heater configured to heat the water. In some embodiments, the system further comprises a watering unit configured to water a plant using the water or configured to provide the water to an animal. In some embodiments, the system further comprises a water flavoring unit configured to add a flavor to the water. In some embodiments, the flavor comprises one or both of fruit or fruit-product. In some embodiments, the flavor comprises a powder, a gel, or a liquid. In some embodiments, the system further comprises a water carbonating unit configured to add carbonation to the water. In some embodiments, the system further comprises a tea unit configured to generate tea using at least the water. In some embodiments, the system further comprises a coffee unit configured to generate coffee using at least the water. In some embodiments, the system further comprises a power source configured to provide power to one or both of the dehumidifier or the fluid filter, wherein the power source comprises one or more of: a solar panel, a crank, a battery, or a turbine.

Another aspect of the present disclosure provides a method for generating water from atmospheric conditions, including: (a) filtering air via an air filter, thereby generating filtered air; (b) heating the filtered air via a first portion of a rotating desiccant core, thereby generating heated air; (c) generating a moist air stream from the heated air via a second portion of the rotating desiccant core; (d) condensing the moist air stream with one or more condensers; and (e) collecting water from the one or more condensers in a first collection tank. In some embodiments, the method further comprises filtering the water, via a water filter, collected from the one or more condensers at (e).

In some embodiments, the method further comprises collecting the water in a pitcher after filtering the water. In some embodiments, the method further comprises monitoring a water level or a water amount of the water within one or both of the first collection tank or the pitcher. In some embodiments, the method further comprises adding one or more minerals to the water. In some embodiments, the method further comprises storing operation data, wherein the operation data comprises one or more of: a volume of the water collected, a total operation time for collecting the water, a temperature of the air, or a humidity of the air. In some embodiments, the method further comprises transmitting the operation data. In some embodiments, the operation data is transmitted to a wireless controller. In some embodiments, the wireless controller is a user device. In some embodiments, the method further comprises generating one or more alerts based on the operation data. In some embodiments, the one or more alerts correspond to one or more of: an indication to replace a water filter, an indication to replace the air filter, a system malfunction, a low water level or water amount of the water within one or both of the first collection tank or the pitcher, or a high water level or water amount of the water within one or both of the first collection tank or the pitcher.

Another aspect of the present disclosure provides a device for atmospheric water generation comprising: (A) a housing including: (i) an air filter, (ii) a dehumidifier comprising a desiccant core in fluid connection with the air filter, a heater in thermal connection with the desiccant core, and a condenser in fluid connection with the desiccant core, (iii) a water filter in fluid connection with the condenser, (iv) a water outflow conduit in fluid connection with the water filter, and (v) a pitcher cavity; and (B) a pitcher physically removable from the pitcher cavity and in fluid connection with the water outflow conduit.

In some embodiments, the housing further comprises an internal control and monitoring assembly. In some embodiments, wherein the housing further comprises an airflow fan in electrical connection with the internal control and monitoring assembly. In some embodiments, the housing further comprises a collection reservoir in fluid connection with the condenser. In some embodiments, the pitcher further comprises an ultraviolet (UV) light. In some embodiments, the UV light is configured to cycle between a powered-on state and a powered-off state at a first frequency. In some embodiments, the first frequency is between 5 minutes and 120 minutes. In some embodiments, the powered-on state is configured to last for a first amount of time. In some embodiments, the first amount of time is between 3 seconds and 30 seconds. In some embodiments, the UV light is configured to direct ultraviolet-C (UV-C) light towards an interior portion of the pitcher. In some embodiments, either the housing or the pitcher further comprises a UV-C light sensor. In some embodiments, either the housing or the pitcher further comprises an alarm, wherein the alarm is configured to generate an alert when the UV light is detected by the UV-C light sensor to have degraded performance. In some embodiments, the housing further comprises one or more sensors configured to determine whether the pitcher is present in the pitcher cavity. In some embodiments, the one or more sensors comprise Hall effect sensors and the pitcher comprises one or more magnets configured to be aligned with the Hall effect sensors when the pitcher is present in the pitcher cavity. In some embodiments, the UV light is mounted on a lid of the pitcher and the UV light charges via inductive charging, and wherein the UV light is configured to be in a powered-off state while the lid is separated from a body of the pitcher. In some embodiments, either the housing or the pitcher further comprises one or more sensors configured to determine a water level or a water amount in the pitcher, and wherein one or more of the dehumidifier, the water filter, or the air filter are configured to disable in response to the water level or the water amount in the pitcher satisfying a threshold. In some embodiments, the one or more sensors comprise one or more of: a capacitive water sensor, a laser distance meter, an ultrasonic distance meter, or a top-down ultrasound. In some embodiments, wherein the pitcher comprises a valve configured to regulate flow of the water for one or both of inflow or outflow from the pitcher, wherein the valve is configured to open when the pitcher is tilted. In some embodiments, the condenser comprises a first collection tank configured to collect water from the desiccant core when the desiccant core is heated by the heater. In some embodiments, the device further comprises a first pump in fluid connection with the first collection tank. In some embodiments, the first pump is configured to pump the water from the first fluid collection tank into the pitcher via the water outflow conduit. In some embodiments, the air filter is removable from the housing. In some embodiments, the air filter comprises a carbon felt filter. In some embodiments, the device further comprises an alarm configured to determine whether air quality of air passing through the air filter satisfies a threshold. In some embodiments, the water filter comprises a filter cartridge that is removable from the housing. In some embodiments, the filter cartridge is configured to perform a two-stage filtration process, and wherein the filter cartridge comprises a first filter and a second filter that is in fluid connection to the first filter. In some embodiments, the first filter is configured to perform particle filtration and the second filter is configured to perform remineralization. In some embodiments, the first filter comprises an electropositive filter membrane. In some embodiments, the second filter adds one or more minerals to the water outflow conduit. In some embodiments, the one or more minerals comprise one or more of: magnesium, carbon, sodium, potassium, manganese, or iron. In some embodiments, the second filter comprises an alkaline filter. In some embodiments, the filter cartridge comprises a radio-frequency identification (RFID) tag.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A depicts a portable atmospheric water generator, according to some embodiments;

FIG. 1B depicts a method of generating water using a portable atmospheric water generator, according to some embodiments;

FIG. 1C depicts a portable atmospheric water generator, according to some embodiments;

FIG. 1D depicts a portable atmospheric water generator, according to some embodiments;

FIG. 2A depicts a portable atmospheric water generator, according to some embodiments;

FIG. 2B depicts a portable atmospheric water generator, according to some embodiments;

FIG. 3A depicts a filter cartridge of a portable atmospheric water generator, according to some embodiments;

FIG. 3B depicts a filter cartridge of a portable atmospheric water generator, according to some embodiments;

FIG. 4 shows a non-limiting example of a computing device; in this case, a device with one or more processors, memory, storage, and a network interface;

FIG. 5 shows a non-limiting example of a web/mobile application provision system; in this case, a system providing browser-based and/or native mobile user interfaces;

FIG. 6 shows a non-limiting example of a cloud-based web/mobile application provision system; in this case, a system comprising an elastically load balanced, auto-scaling web server and application server resources as well synchronously replicated databases;

FIG. 7A depicts a portable atmospheric water generator with a pitcher located internally, according to some embodiments;

FIG. 7B depicts a portable atmospheric water generator with a pitcher located internally, according to some embodiments;

FIG. 8 depicts a portable atmospheric water generator with a pitcher located externally, according to some embodiments;

FIG. 9A depicts a non-limiting example of a pitcher, according to some embodiments;

FIG. 9B depicts a non-limiting example of a pitcher, according to some embodiments;

FIG. 10A depicts a non-limiting example of a pitcher, according to some embodiments;

FIG. 10B depicts a non-limiting example of a lid portion of a pitcher, according to some embodiments;

FIG. 11A depicts a non-limiting example of a pitcher cavity of a portable water generator, according to some embodiments;

FIG. 11B depicts a non-limiting example of a pitcher, according to some embodiments;

FIG. 12 shows example dimensions of a pitcher, according to some embodiments;

FIG. 13 shows example dimensions of a portable water generator, according to some embodiments;

FIG. 14A depicts a non-limiting example of a portable water generator, according to some embodiments;

FIG. 14B depicts a non-limiting example of a portable water generator, according to some embodiments;

FIG. 14C depicts a non-limiting example of a portable water generator, according to some embodiments;

FIG. 14D depicts a non-limiting example of a portable water generator, according to some embodiments; and

FIG. 15 depicts a non-limiting example of a portable water generator, according to some embodiments;

FIG. 16 depicts a non-limiting example of a process for generating drinking water, according to some embodiments; and

FIG. 17 depicts a non-limiting example of a method for generating water from atmospheric conditions, according to some embodiments.

### DETAILED DESCRIPTION

Provided herein are embodiments of systems and methods for generating potable water from the atmosphere using a portable atmospheric water generator. In some embodiments, the portable atmospheric water generator is a wirelessly controlled device. In some embodiments, the portable atmospheric water generator is not a wirelessly controlled device (e.g., the portable atmospheric water generator may be controlled using one or more built in controls). In some embodiments, the portable atmospheric water generator has externally controlled wireless operation controls which eliminate the bulk of the controls from the footprint of the device which control an atmospheric water generator. In some embodiments, the wireless controls of the portable atmospheric water generator can be utilized by existing technology, such as a smart phone. In some embodiments, the portable atmospheric water generator comprises a desiccant based condensing unit, in electrical connection with an internal control and monitoring assembly. In some embodiments a desiccant based condensing unit comprising a desiccant core, a heating element in thermal connection with the desiccant core; a re-circulating fan; and a drive motor. In some embodiments, the portable atmospheric water generator comprises a collection tank having an internal float switch is positioned in aqueous connection with the refrigeration condensing unit. In some embodiments, the portable atmospheric water generator comprises a pump, in electrical connection with the internal control and monitoring assembly, which transfers condensed water from the collection tank into a water filtration system. In some embodiments, a potable water outflow conduit delivers water to the exterior of the portable atmospheric water generator housing.

In some embodiments, a method of generating water using a wirelessly controlled system and device for atmospheric water generation is provided. In some embodiments, a wireless external control for operation and control of the device for atmospheric water generation is provided. One or more system operation parameters or water collection data from the wireless internal control system may be wirelessly provided to the wireless external control from an internal control and monitoring system of the atmospheric water generation device. In some embodiments, one or more system operation parameters or one or more water collection data are wirelessly provided from the wireless internal control system to the wireless external control. In some embodiments, a user is able to select a plurality of operation parameters from a display on the wireless external control, which are then wirelessly transmitted to the atmospheric water generation device. The atmospheric water generation device generates filtered potable water according to the operation parameters until the provided user set operation parameters automatically terminate the generation of the filtered potable water.

### Example Operating Conditions

In some embodiments, the portable atmospheric water generator is operable in humidity levels of about 1% to about 100%. In some embodiments, the portable atmospheric water generator is operable in humidity levels of about 1% to about 5%, about 1% to about 10%, about 1% to about 20%, about 1% to about 30%, about 1% to about 40%, about 1% to about 50%, about 1% to about 60%, about 1% to about 70%, about 1% to about 80%, about 1% to about 90%, about 1% to about 100%, about 5% to about 10%, about 5% to about 20%, about 5% to about 30%, about 5% to about 40%, about 5% to about 50%, about 5% to about 60%, about 5% to about 70%, about 5% to about 80%, about 5% to about 90%, about 5% to about 100%, about 10% to about 20%, about 10% to about 30%, about 10% to about 40%, about 10% to about 50%, about 10% to about 60%, about 10% to about 70%, about 10% to about 80%, about 10% to about 90%, about 10% to about 100%, about 20% to about 30%, about 20% to about 40%, about 20% to about 50%, about 20% to about 60%, about 20% to about 70%, about 20% to about 80%, about 20% to about 90%, about 20% to about 100%, about 30% to about 40%, about 30% to about 50%, about 30% to about 60%, about 30% to about 70%, about 30% to about 80%, about 30% to about 90%, about 30% to about 100%, about 40% to about 50%, about 40% to about 60%, about 40% to about 70%, about 40% to about 80%, about 40% to about 90%, about 40% to about 100%, about 50% to about 60%, about 50% to about 70%, about 50% to about 80%, about 50% to about 90%, about 50% to about 100%, about 60% to about 70%, about 60% to about 80%, about 60% to about 90%, about 60% to about 100%, about 70% to about 80%, about 70% to about 90%, about 70% to about 100%, about 80% to about 90%, about 80% to about 100%, or about 90% to about 100%. In some embodiments, the portable atmospheric water generator is operable in humidity levels of about 1%, about 5%, about 10%, about 20%, about 30%, about 40%, about 50%, about 60%, about 70%, about 80%, about 90%, or about 100%. In some embodiments, the portable atmospheric water generator is operable in humidity levels of at least about 1%, about 5%, about 10%, about 20%, about 30%, about 40%, about 50%, about 60%, about 70%, about 80%, or about 90%. In some embodiments, the portable atmospheric water generator is operable in humidity levels of at most about 5%, about 10%, about 20%, about 30%, about 40%, about 50%, about 60%, about 70%, about 80%, about 90%, or about 100%.

In some embodiments, the portable atmospheric water generator is operable in relative humidity levels of about 1% to about 100%. In some embodiments, the portable atmospheric water generator is operable in relative humidity levels of about 1% to about 5%, about 1% to about 10%, about 1% to about 20%, about 1% to about 30%, about 1% to about 40%, about 1% to about 50%, about 1% to about 60%, about 1% to about 70%, about 1% to about 80%, about 1% to about 90%, about 1% to about 100%, about 5% to about 10%, about 5% to about 20%, about 5% to about 30%, about 5% to about 40%, about 5% to about 50%, about 5% to about 60%, about 5% to about 70%, about 5% to about 80%, about 5% to about 90%, about 5% to about 100%, about 10% to about 20%, about 10% to about 30%, about 10% to about 40%, about 10% to about 50%, about 10% to about 60%, about 10% to about 70%, about 10% to about 80%, about 10% to about 90%, about 10% to about 100%, about 20% to about 30%, about 20% to about 40%, about 20% to about 50%, about 20% to about 60%, about 20% to about 70%, about 20% to about 80%, about 20% to about 90%, about 20% to about 100%, about 30% to about 40%, about 30% to about 50%, about 30% to about 60%, about 30% to about 70%, about 30% to about 80%, about 30% to about 90%, about 30% to about 100%, about 40% to about 50%, about 40% to about 60%, about 40% to about 70%, about 40% to about 80%, about 40% to about 90%, about 40% to about 100%, about 50% to about 60%, about 50% to about 70%, about 50% to about 80%, about 50% to about 90%, about 50% to about 100%, about 60% to about 70%, about 60% to about 80%, about 60% to about 90%, about 60% to about 100%, about 70% to about 80%, about 70% to about 90%, about 70% to about 100%, about 80% to about 90%, about 80% to about 100%, or about 90% to about 100%. In some embodiments, the portable atmospheric water generator is operable in relative humidity levels of about 1%, about 5%, about 10%, about 20%, about 30%, about 40%, about 50%, about 60%, about 70%, about 80%, about 90%, or about 100%. In some embodiments, the portable atmospheric water generator is operable in relative humidity levels of at least about 1%, about 5%, about 10%, about 20%, about 30%, about 40%, about 50%, about 60%, about 70%, about 80%, or about 90%. In some embodiments, the portable atmospheric water generator is operable in relative humidity levels of at most about 5%, about 10%, about 20%, about 30%, about 40%, about 50%, about 60%, about 70%, about 80%, about 90%, or about 100%.

In some embodiments, the portable atmospheric water generator is operable in temperatures of about −1° C. to about 38° C. In some embodiments, the portable atmospheric water generator is operable in temperatures of about −1° C. to about 4° C., about −1° C. to about 10° C., about −1° C to about 16° C., about −1° C to about 21° C., about −1° C to about27° C., about −1° C. to about 32° C., about −1° C. to about 38° C., about 4° C. to about 10° C., about 4° C. to about 16° C., about 4° C to about 21° C., about 4° C to about 27° C., about 4° C to about 32° C., about 4° C. to about 38° C., about 10° C. to about 16° C., about 10° C. to about 21° C., about 10° C. to about 27° C., about 10° C to about 32° C., about 10° C to about 38° C., about 16° C to about 21° C., about 16° C. to about 27° C., about 16° C. to about 32° C., about 16° C. to about 8° C., about 21° C. to about 27° C., about 21° C to about 32° C., about 21° C to about 38° C., about 27° C to about 32° C., about 27° C to about 38° C., or about 32° C to about 38° C. In some embodiments, the portable atmospheric water generator is operable in temperatures of about −1° C., about 4° C., about 10° C., about 16° C., about 21° C., about 27° C., about 32° C., or about 38° C. In some embodiments, the portable atmospheric water generator is operable in temperatures of at least about −1° C., about 4° C., about 10° C., about 16° C., about 21° C., about 27° C., or about 32° C. In some embodiments, the portable atmospheric water generator is operable in temperatures of at most about 4° C., about 10° C., about 16° C., about 21° C., about 27° C., about 32° C., or about 38° C.

### Example Atmospheric Water Generator

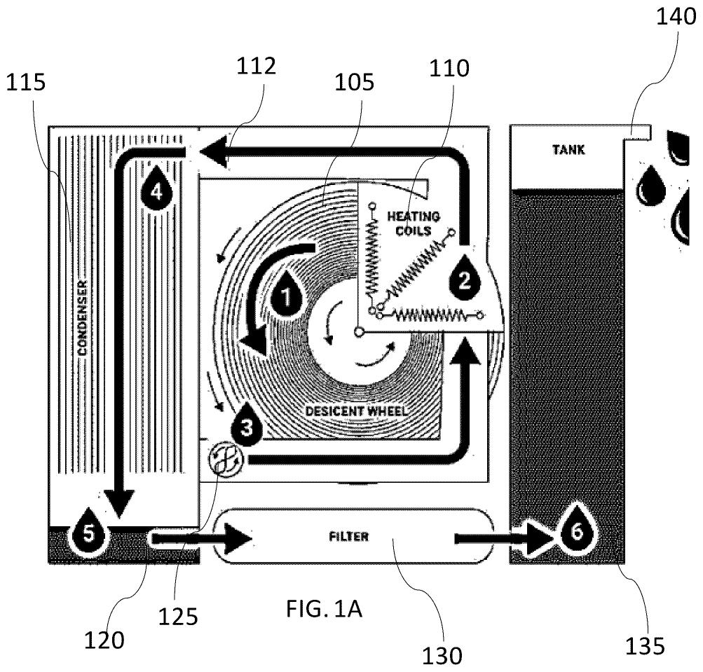

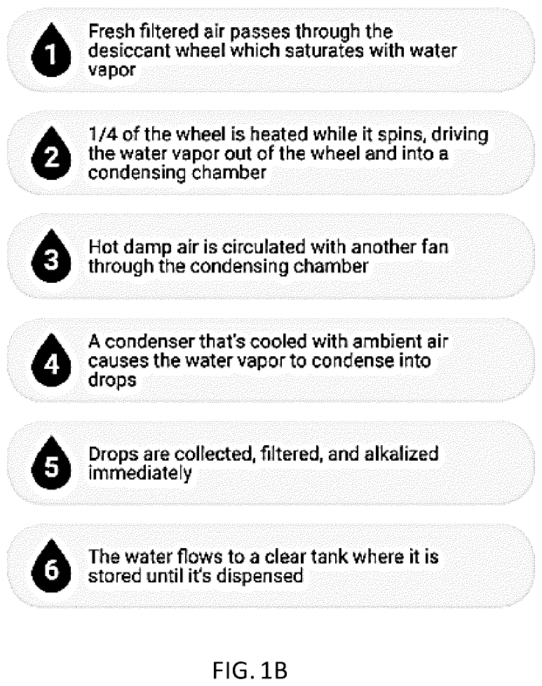

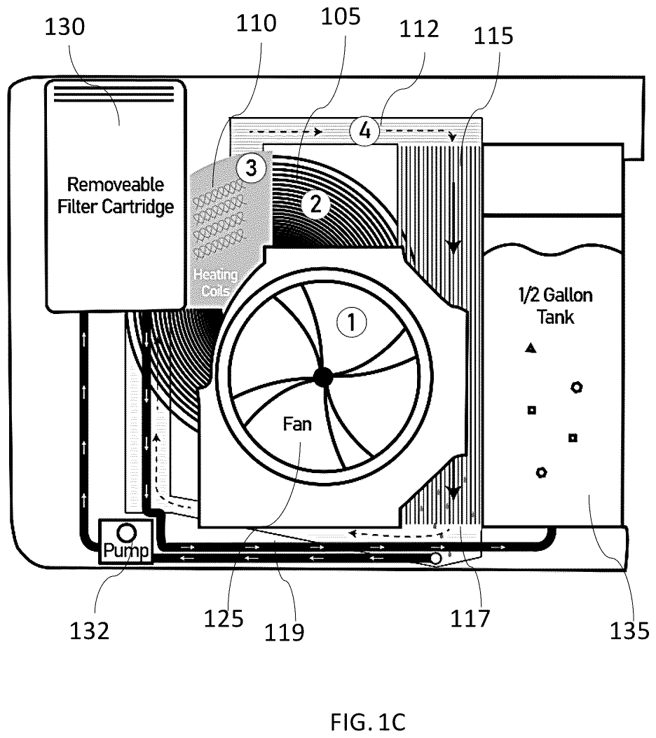

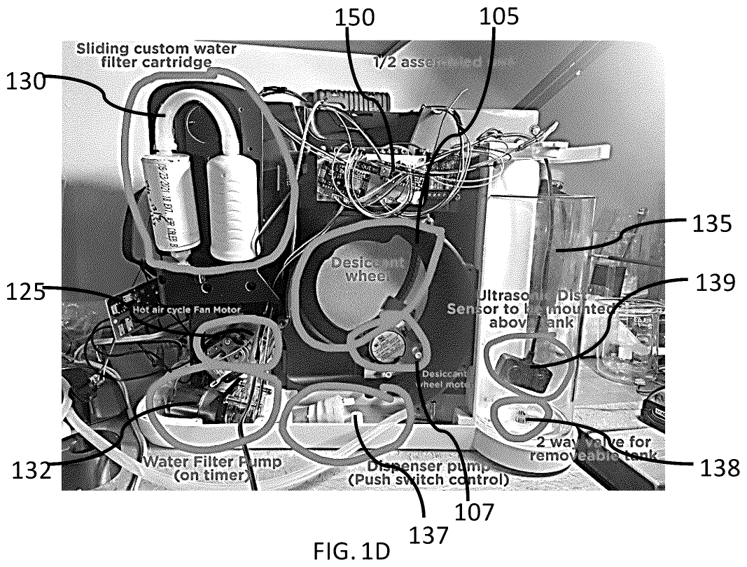

With reference to FIGS. 1A, 1C, and 1D, an example of a portable atmospheric water generator device is depicted, according to some embodiments. In some embodiments, the water generator comprises a desiccant core 105. In some embodiments, the desiccant core 105 is provided as a disc or wheel. The desiccant core 105 may be connected to a motor 107 to rotate the desiccant core 105 about its center axis. In some embodiments, the water generator further comprises a heat source 110 and fan 125 for providing a hot air stream directed at the desiccant core 105. In some embodiments, the speed of the fan is variable. In some embodiments, the speed of the fan is automatically varied based on the ambient humidity and/or temperature sensed by the device. In some embodiments, the heat source 110 comprises one or more heating coils. In some embodiments, the hot air stream directed at the desiccant core creates a stream of moist air, having a high humidity percentage. In some embodiments, the desiccant core 105 is removable to facilitate replacement of the core after a period of time or expiry date.

In some embodiments, the moist air flow is directed by a fluid conduit 112 towards a condensing unit 115. In some embodiments, the condensing unit 115 comprises one or more condensation tubes. In some embodiments, the one or more condensation tubes are comprised of glass, plastic, metal, other suitable materials, or combinations thereof. In some embodiments, as water condenses within the condensation unit 115, the water is collected within a first reservoir or tank 117. In some embodiments, a second fluid conduit 119 is provided to direct the airflow from the condensation unit 115 and back towards the heat source 110 to maintain a circulatory airflow within the water generator device.

In some embodiments, condensed water collected within the first reservoir 117 is in fluid communication with a first pump 132. In some embodiments, the first pump 132 pumps the water from the first reservoir 117 through the filter cartridge 130. In some embodiments, the first pump 132 is a positive-displacement pump, a centrifugal pump, or an axial flow pump. In some embodiments, the first pump 132 is a peristaltic pump. In some embodiments, the first pump 132 is coupled to a water level sensor to avoid air from entering the pump. In some embodiments, the filter cartridge is a two stage cartridge comprising two filters coupled in fluid communication, as described herein.

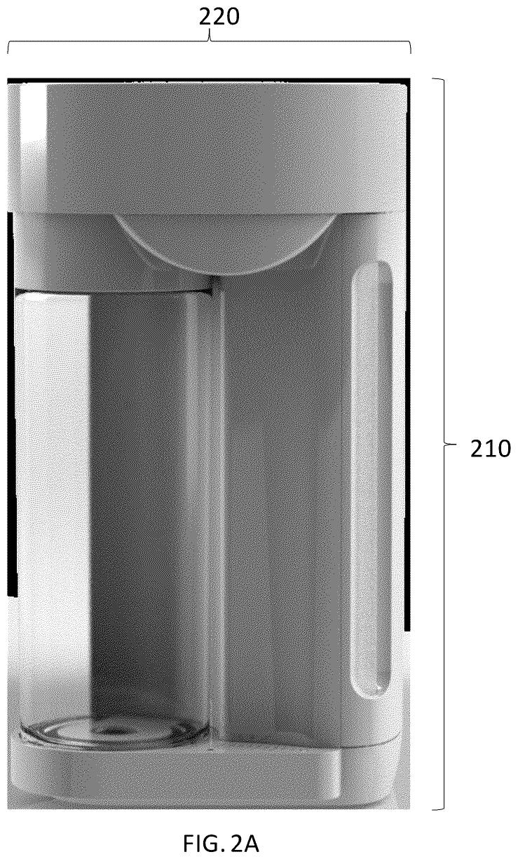

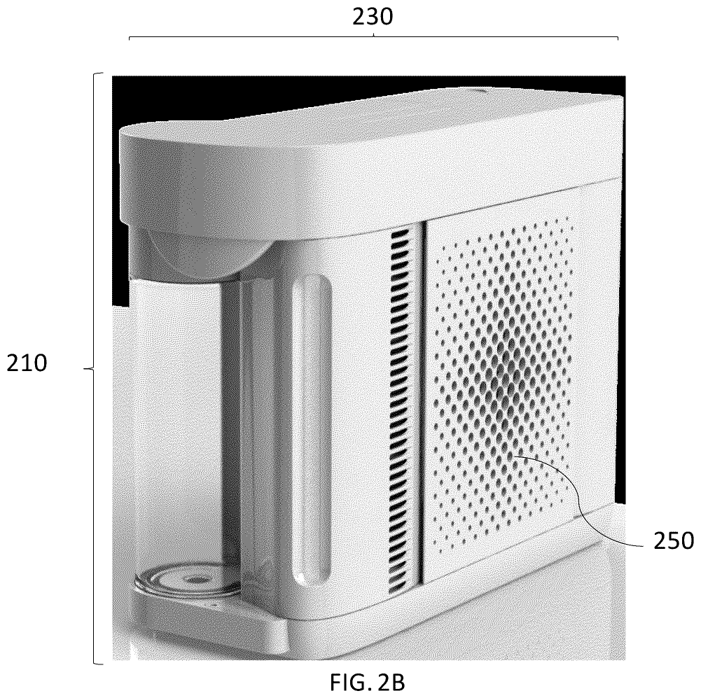

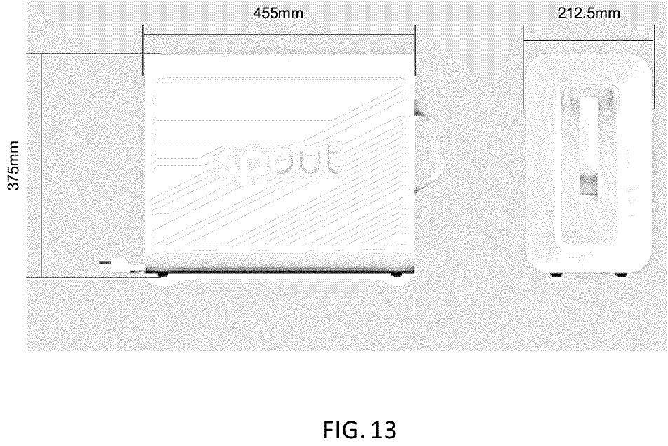

FIGS. 2A and 2B depict external views of the water generator device. In some embodiments, the water generator device comprises a height 210 of about 38 cm, a width 220 of about 50 cm, and a depth of about 25 cm. FIG. 13 further depicts non-limiting external views of the water generator device with non-limiting dimensions. In some embodiments, the water generator device comprises a height of about 375 mm, a width of about 455 mm, and a depth of about 213 mm. In some embodiments, the device comprises a housing. In some embodiments, the total space occupied by the device is no more than about 330 square centimeters (cm²). In some embodiments, the total space occupied by the device is about 200 cm² to about 600 cm². In some embodiments, the total space occupied by the device is about 200 cm² to about 250 cm², about 200 cm² to about 300 cm², about 200 cm² to about 350 cm², about 200 cm² to about 400 cm², about 200 cm² to about 450 cm², about 200 cm² to about 500 cm², about 200 cm² to about 550 cm², about 200 cm² to about 600 cm², about 250 cm² to about 300 cm², about 250 cm² to about 350 cm², about 250 cm² to about 400 cm², about 250 cm² to about 450 cm², about 250 cm² to about 500 cm², about 250 cm² to about 550 cm², about 250 cm² to about 600 cm², about 300 cm² to about 350 cm², about 300 cm² to about 400 cm², about 300 cm² to about 450 cm², about 300 cm² to about 500 cm², about 300 cm² to about 550 cm², about 300 cm² to about 600 cm², about 350 cm² to about 400 cm², about 350 cm² to about 450 cm², about 350 cm² to about 500 cm², about 350 cm² to about 550 cm², about 350 cm² to about 600 cm², about 400 cm² to about 450 cm², about 400 cm² to about 500 cm², about 400 cm² to about 550 cm², about 400 cm² to about 600 cm², about 450 cm² to about 500 cm², about 450 cm² to about 550 cm², about 450 cm² to about 600 cm², about 500 cm² to about 550 cm², about 500 cm² to about 600 cm², or about 550 cm² to about 600 cm². In some embodiments, the total space occupied by the device is about 200 cm², about 250 cm², about 300 cm², about 350 cm², about 400 cm², about 450 cm², about 500 cm², about 550 cm², or about 600 cm². In some embodiments, the total space occupied by the device is at least about 200 cm², about 250 cm², about 300 cm², about 350 cm², about 400 cm², about 450 cm², about 500 cm², or about 550 cm². In some embodiments, the total space occupied by the device is at most about 250 cm², about 300 cm², about 350 cm², about 400 cm², about 450 cm², about 500 cm², about 550 cm², or about 600 cm².

In some embodiments, as shown in FIG. 2B, the water generator device comprises an air filter cover 250. In some embodiments, the air filter cover 250 comprises perforations to allow air to be pulled through the air filter and device. In some embodiments, the air filter filters air prior to the air condensing in the water generator device. In some embodiments, the air filter covers the intake fan (e.g., fan 125 as depicted in FIG. 1C) to filter air pulled into the device by the intake fan 125. In some embodiments, the air filter cover 250 couples to the housing of the device via magnets. In some embodiments, the air filter is a MERV 13 rated filter. In some embodiments, the air filter is a carbon felt filter.

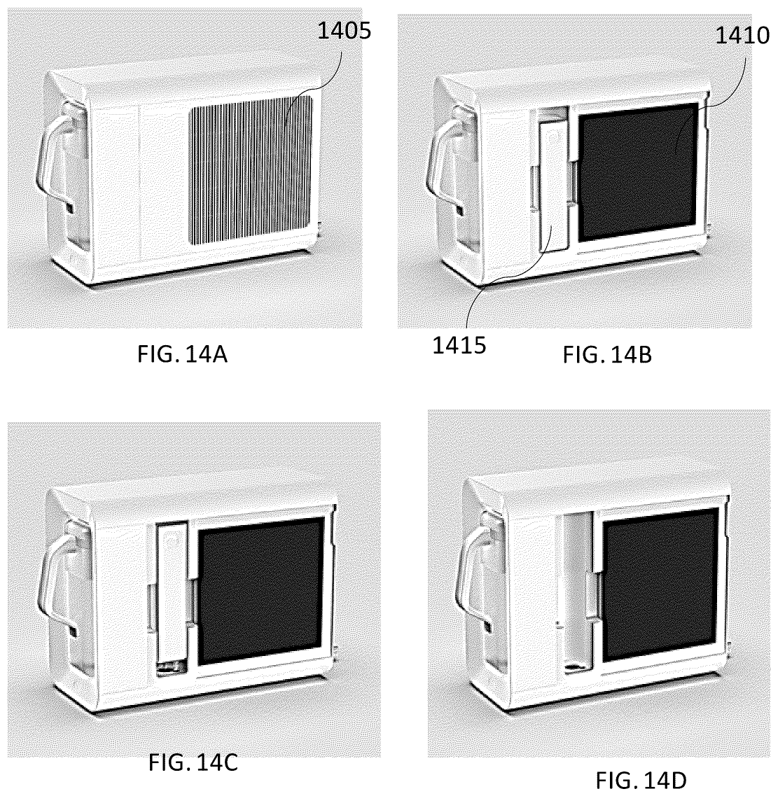

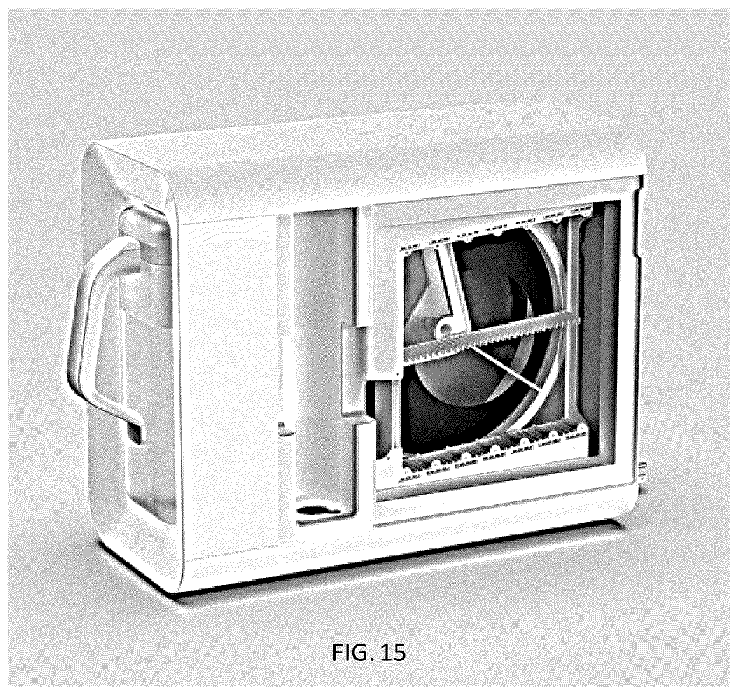

In some embodiments, as shown in FIGS. 14A to 15, the air filter 1410 is removable. For example, FIG. 14A shows a water generator device with an air filter cover 1405 attached. FIGS. 14B to 14D show a water generator device with an air filter 1410 exposed. FIG. 15 shows a water generator device without an air filter cover 1405 or an air filter 1410.

In some embodiments, the water generator device comprises an air quality monitor or sensor. In some embodiments, the air quality monitor or sensor comprises one or more sensors to determine if ambient air is suitable for water production. In some embodiments, the air quality monitor or sensor monitors air air quality of the air at one or both of a time (i) before the air is filtered by the air filter, or (ii) after the air is filtered by the air filter. In some embodiments, the one or more sensors are in communication with one or more lights. In some embodiments, when the one or more sensors determines that air is suitable for water production, the one or more lights display one color that is different than the color displayed when the one or more sensors determines that air is not suitable for water production. For example, if the air is suitable for water production, the lights may turn green, whereas if the air is not suitable for water production, the lights may turn red. In some embodiments, the lights may be used to indicate any other number of conditions or parameters associated with the water generator or ambient conditions. For example, the light may indicate device malfunctions, power levels, water levels, water quality, water temperatures, air temperatures, subscription payment/renewal, filter replacement, etc.

In some embodiments, the water generator device may comprise a water chiller. The water chiller may cool or chill the water to a particular temperature. In some embodiments, the water generator device may comprise a water heater. The water heater may heat the water to a particular temperature. In some embodiments, the water generator device may comprise a watering unit. In some embodiments, the watering unit may water a plant. In some embodiments, the watering unit may provide water to an animal.

In some embodiments, the water generator device may comprise a power control operable by a user. The power control may be a capacitive touch sensor, in some embodiments. In some embodiments, the power control may enable selecting one or more of a powered-off state, a low-power state, a mid-power state, a high-power state, a powered-on state, etc. In some embodiments, the amount power (e.g., low power, high power, etc.) may be selected automatically based at least in part on the availability of the power source for the water generator device. For example, if the water generator device is being powered by a renewable energy source (e.g., solar, wind, hydropower, etc.) a lower power state (e.g., the low-power state) may be automatically selected; whereas if the water generator device is being powered by a higher power or more reliable energy source (e.g., a wall outlet) a higher power state may be automatically selected. Different power state may correspond to different rates for operating one or more components of the water generator device and may, in turn, affect water generation rates.

### Example Pitcher

In some embodiments, filtered water from the filter cartridge is output into a pitcher 805. In some embodiments, the water may be collected in the pitcher 805 directly (e.g., without first being collected in the first reservoir 117). In some embodiments, the water may be collected in the pitcher 805 after being previously collected in the first reservoir 117.

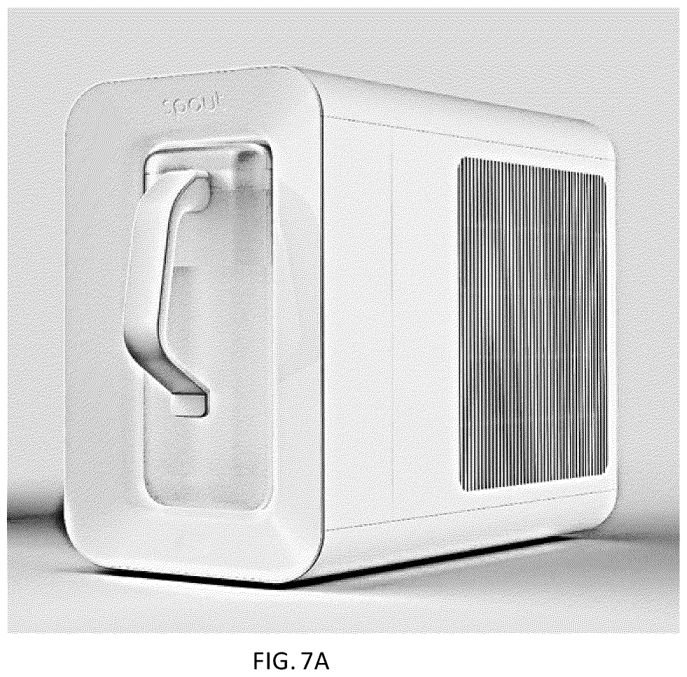

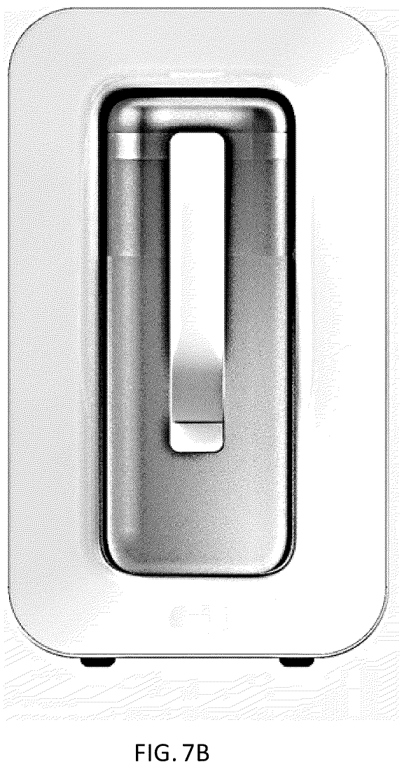

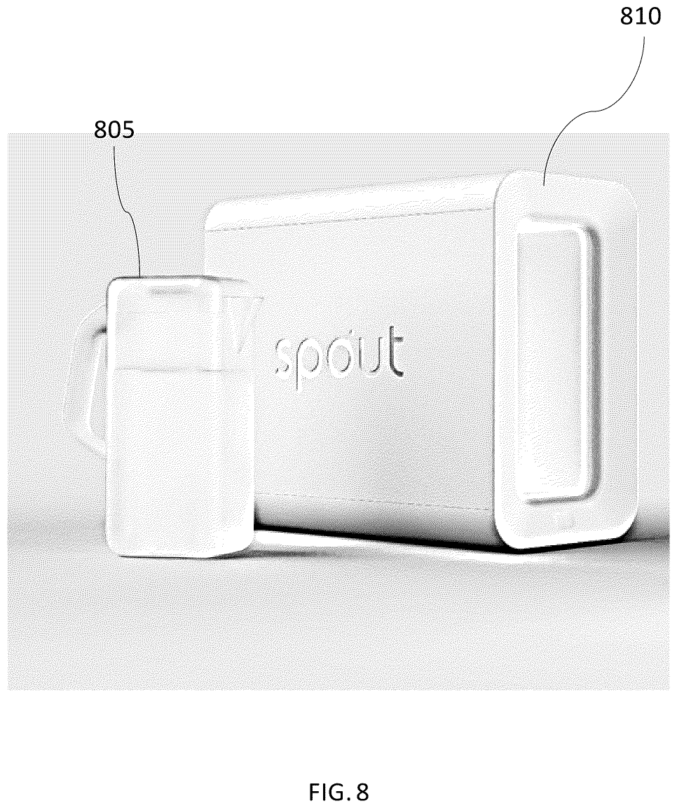

In some embodiments, the pitcher 805 is held in the water generator within a pitcher cavity 810 of the housing of the water generator. FIGS. 7A and 7B show the water generator device with the pitcher held internally in the pitcher cavity of the housing of the water generator. In some embodiments, the pitcher is removeable from the housing of the water generator. FIG. 8 shows the pitcher 805 separate from the housing of the water generator. FIG. 8 also shows the pitcher cavity 810 of the housing of the water generator.

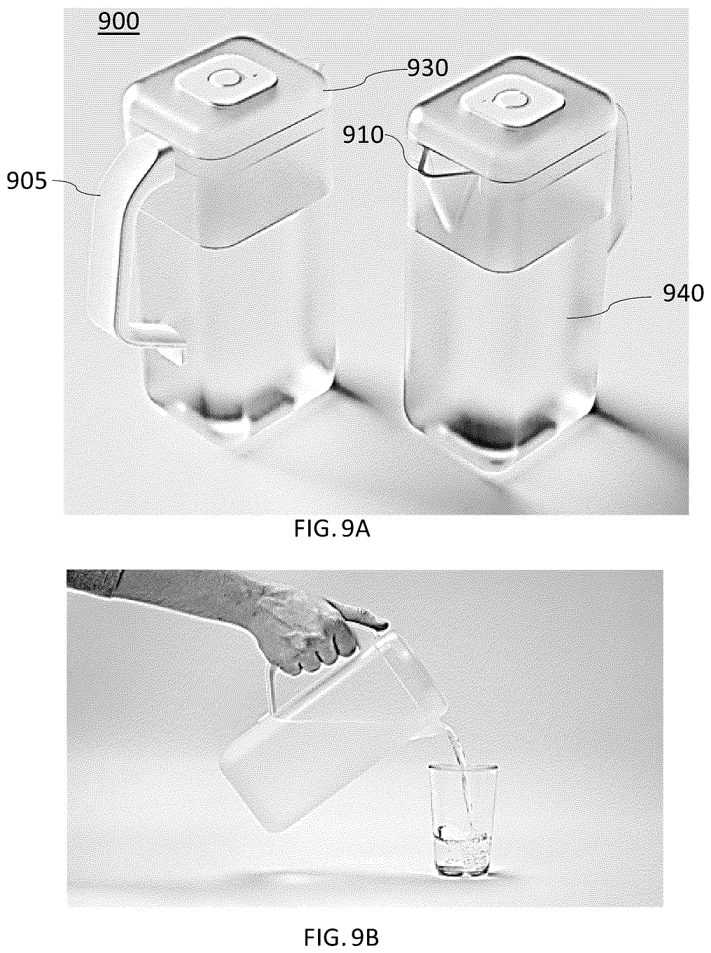

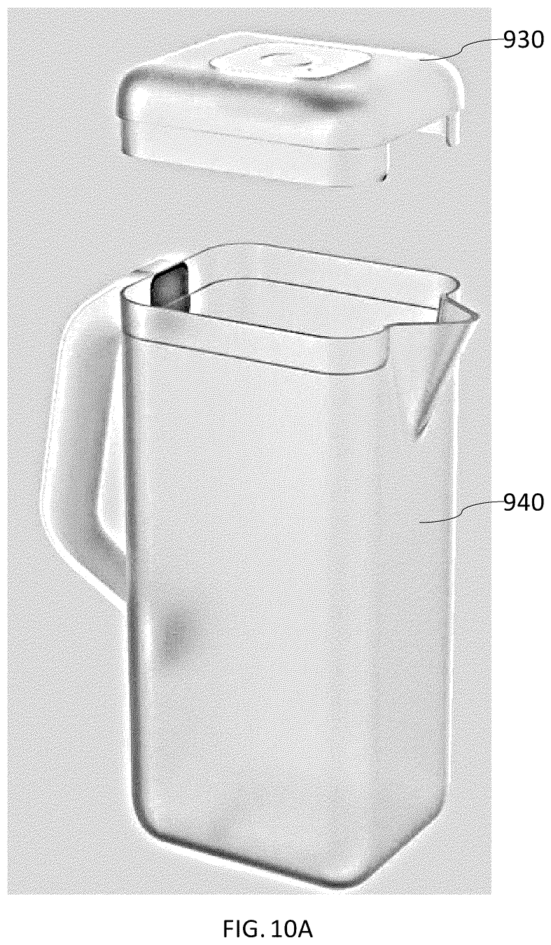

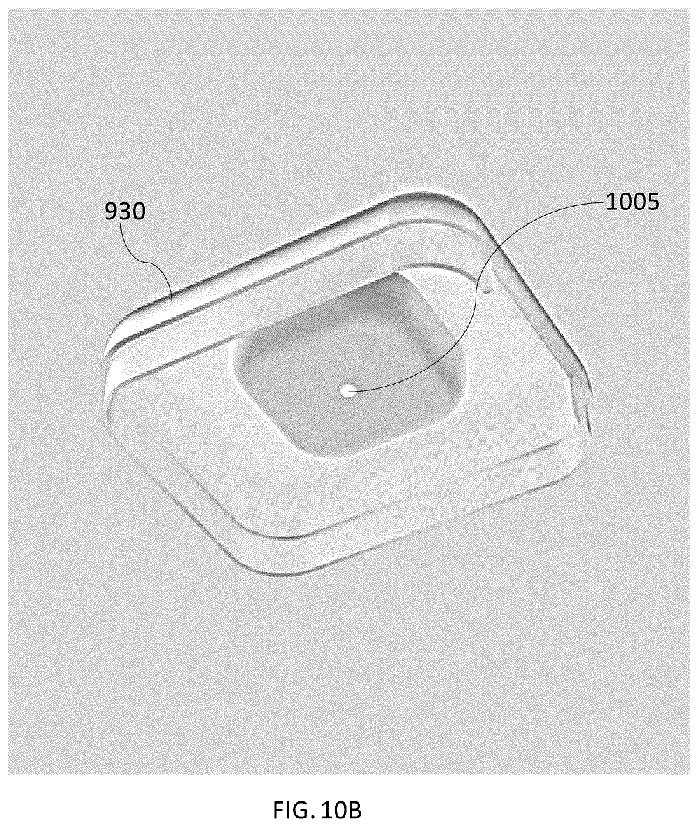

FIGS. 9A, 9B, 10A, 10B, and 11B show various features of the pitcher 900. As shown in FIGS. 9A and 9B, in some embodiments, the pitcher 900 may comprise a handle 905. The handle 905 may help a user hold and move the pitcher 900 to pour out fluid stored in the pitcher 900. The pitcher 900 may also comprise a lid portion 930 and a body portion 940 that may be separated (see, for example, FIG. 10A). The pitcher 900 may also comprise a spout 910 to help direct fluid out of the pitcher 900 (e.g., in a glass) as shown in FIG. 9B. The pitcher 900 may also comprise a valve. The valve may regulate the flow of water into the pitcher 900, out of the pitcher 900, or both into and out of the pitcher 900 The valve may be configured to open when the pitcher 900 is tilted. For example, the valve may use a float technique so that the valve opens when the pitcher is tilted (e.g., to enable water being poured) and closes when the pitcher is upright (e.g., to prevent ambient contamination from entering the pitcher 900).

In some embodiments, the pitcher 900 may comprise an ultraviolet (UV) light 1005 on the lid portion 930. In some embodiments, a sensor may be present to detect when the lid portion 930 is separated from the body portion 940 so that the UV light 1005 may be prevented from turning on while the two are separated (e.g., to avoid shining UV light into a user's eyes). The UV light 1005 may communicate to a user the purity of the fluid (e.g., water, flavored water, carbonated water, tea, coffee, etc.) in the pitcher 900. FIGS. 10A and 10B show non-limiting examples of the UV light 1005 on the lid portion 930 of the pitcher 900. In some embodiments, the light is run every 1 second to every 50 seconds. In some embodiments, the light is run every 1 second to 3 seconds, every 1 second to 5 seconds, everyone 1 second to 10 seconds, every 1 second to 15 seconds, every 1 second to 20 seconds, 1 second to 25 seconds, 1 second to 30 seconds, 1 second to 35 seconds, 1 second to 40 seconds, 1 second to 45 seconds, 1 second to 50 seconds, 3 seconds to 5 seconds, 3 seconds to 10 seconds, 3 seconds to 15 seconds, 3 seconds to 20 seconds, 3 seconds to 25 seconds, 3 seconds to 30 seconds, 3 seconds to 35 seconds, 3 seconds to 40 seconds, 3 seconds to 45 seconds, 3 seconds to 50 seconds, 5 seconds to 10 seconds, 5 seconds to 15 seconds, 5 seconds to 20 seconds, 5 seconds to 25 seconds, 5 seconds to 30 seconds, 5 seconds to 35 seconds, 5 seconds to 40 seconds, 5 seconds to 45 seconds, 5 seconds to 50 seconds, 10 seconds to 15 seconds, 10 seconds to 20 seconds, 10 seconds to 25 seconds, 10 seconds to 30 seconds, 10 seconds to 35 seconds, 10 seconds to 40 seconds, 10 seconds to 45 seconds, 10 seconds to 50 seconds, 15 seconds to 20 seconds, 15 seconds to 25 seconds, 15 seconds to 30 seconds, 15 seconds to 35 seconds, 15 seconds to 40 seconds, 15 seconds to 45 seconds, 15 seconds to 50 seconds, 20 seconds to 25 seconds, 20 seconds to 30 seconds, 20 seconds to 35 seconds, 20 seconds to 40 seconds, 20 seconds to 45 seconds, 20 seconds to 50 seconds, 25 seconds to 30 seconds, 25 seconds to 35 seconds, 25 seconds to 40 seconds, 25 seconds to 45 seconds, 25 seconds to 50 seconds, 30 seconds to 35 seconds, 30 seconds to 40 seconds, 30 seconds to 45 seconds, 30 seconds to 50 seconds, 35 seconds to 40 seconds, 35 seconds to 45 seconds, 35 seconds to 50 seconds, 40 seconds to 45 seconds, 40 seconds to 50 seconds, or 45 seconds to 50 seconds. In some embodiments, the light is run every 1 second, 3 seconds, 5 seconds, 10 seconds, 15 seconds, 20 seconds, 25 seconds, 30 seconds, 35 seconds, 40 seconds, 45 seconds, or 50 seconds. In some embodiments, the light is run every at least 1 second, 3 seconds, 5 seconds, 10 seconds, 15 seconds, 20 seconds, 25 seconds, 30 seconds, 35 seconds, 40 seconds, or 45 seconds. In some embodiments, the light is run every at most 3 seconds, 5 seconds, 10 seconds, 15 seconds, 20 seconds, 25 seconds, 30 seconds, 35 seconds, 40 seconds, 45 seconds, or 50 seconds. In some embodiments, the light is run every 1 minute to 20 minutes. In some embodiments, the light is run every 1 minute to 2 minutes, 1 minute to 3 minutes, 1 minute to 4 minutes, 1 minute to 5 minutes, 1 minute to 6 minutes, 1 minute to 7 minutes, 1 minute to 8 minutes, 1 minute to 9 minutes, 1 minute to 10 minutes, 1 minute to 15 minutes, 1 minute to 20 minutes, 2 minutes to 3 minutes, 2 minutes to 4 minutes, 2 minutes to 5 minutes, 2 minutes to 6 minutes, 2 minutes to 7 minutes, 2 minutes to 8 minutes, 2 minutes to 9 minutes, 2 minutes to 10 minutes, 2 minutes to 15 minutes, 2 minutes to 20 minutes, 3 minutes to 4 minutes, 3 minutes to 5 minutes, 3 minutes to 6 minutes, 3 minutes to 7 minutes, 3 minutes to 8 minutes, 3 minutes to 9 minutes, 3 minutes to 10 minutes, 3 minutes to 15 minutes, 3 minutes to 20 minutes, 4 minutes to 5 minutes, 4 minutes to 6 minutes, 4 minutes to 7 minutes, 4 minutes to 8 minutes, 4 minutes to 9 minutes, 4 minutes to 10 minutes, 4 minutes to 15 minutes, 4 minutes to 20 minutes, 5 minutes to 6 minutes, 5 minutes to 7 minutes, 5 minutes to 8 minutes, 5 minutes to 9 minutes, 5 minutes to 10 minutes, 5 minutes to 15 minutes, 5 minutes to 20 minutes, 6 minutes to 7 minutes, 6 minutes to 8 minutes, 6 minutes to 9 minutes, 6 minutes to 10 minutes, 6 minutes to 15 minutes, 6 minutes to 20 minutes, 7 minutes to 8 minutes, 7 minutes to 9 minutes, 7 minutes to 10 minutes, 7 minutes to 15 minutes, 7 minutes to 20 minutes, 8 minutes to 9 minutes, 8 minutes to 10 minutes, 8 minutes to 15 minutes, 8 minutes to 20 minutes, 9 minutes to 10 minutes, 9 minutes to 15 minutes, 9 minutes to 20 minutes, 10 minutes to 15 minutes, 10 minutes to 20 minutes, or 15 minutes to 20 minutes. In some embodiments, the light is run every 1 minute, 2 minutes, 3 minutes, 4 minutes, 5 minutes, 6 minutes, 7 minutes, 8 minutes, 9 minutes, 10 minutes, 15 minutes, or 20 minutes. In some embodiments, the light is run every at least 1 minute, 2 minutes, 3 minutes, 4 minutes, 5 minutes, 6 minutes, 7 minutes, 8 minutes, 9 minutes, 10 minutes, or 15 minutes. In some embodiments, the light is run every at most 2 minutes, 3 minutes, 4 minutes, 5 minutes, 6 minutes, 7 minutes, 8 minutes, 9 minutes, 10 minutes, 15 minutes, or 20 minutes. In some embodiments, the light is run every about 20 minutes to about 480 minutes. In some embodiments, the light is run every about 20 minutes to about 30 minutes, about 20 minutes to about 60 minutes, about 20 minutes to about 90 minutes, about 20 minutes to about 120 minutes, about 20 minutes to about 150 minutes, about 20 minutes to about 180 minutes, about20 minutes to about 240 minutes, about20 minutes to about 300 minutes, about 20 minutes to about 360 minutes, about 20 minutes to about 420 minutes, about 20 minutes to about 480 minutes, about 30 minutes to about 60 minutes, about 30 minutes to about 90 minutes, about 30 minutes to about 120 minutes, about 30 minutes to about 150 minutes, about 30 minutes to about 180 minutes, about 30 minutes to about 240 minutes, about 30 minutes to about 300 minutes, about 30 minutes to about 360 minutes, about 30 minutes to about 420 minutes, about 30 minutes to about 480 minutes, about 60 minutes to about 90 minutes, about 60 minutes to about 120 minutes, about 60 minutes to about 150 minutes, about 60 minutes to about 180 minutes, about 60 minutes to about 240 minutes, about 60 minutes to about 300 minutes, about 60 minutes to about 360 minutes, about 60 minutes to about 420 minutes, about 60 minutes to about 480 minutes, about 90 minutes to about 120 minutes, about 90 minutes to about 150 minutes, about 90 minutes to about 180 minutes, about 90 minutes to about 240 minutes, about 90 minutes to about 300 minutes, about 90 minutes to about 360 minutes, about 90 minutes to about 420 minutes, about 90 minutes to about 480 minutes, about 120 minutes to about 150 minutes, about 120 minutes to about 180 minutes, about 120 minutes to about 240 minutes, about 120 minutes to about 300 minutes, about 120 minutes to about 360 minutes, about 120 minutes to about 420 minutes, about 120 minutes to about 480 minutes, about 150 minutes to about 180 minutes, about 150 minutes to about 240 minutes, about 150 minutes to about 300 minutes, about 150 minutes to about 360 minutes, about 150 minutes to about 420 minutes, about 150 minutes to about 480 minutes, about 180 minutes to about 240 minutes, about 180 minutes to about 300 minutes, about 180 minutes to about 360 minutes, about 180 minutes to about 420 minutes, about 180 minutes to about 480 minutes, about 240 minutes to about 300 minutes, about 240 minutes to about 360 minutes, about 240 minutes to about 420 minutes, about 240 minutes to about 480 minutes, about 300 minutes to about 360 minutes, about 300 minutes to about 420 minutes, about 300 minutes to about 480 minutes, about 360 minutes to about 420 minutes, about 360 minutes to about 480 minutes, or about 420 minutes to about 480 minutes. In some embodiments, the light is run every about 20 minutes, about 30 minutes, about 60 minutes, about 90 minutes, about 120 minutes, about 150 minutes, about 180 minutes, about 240 minutes, about 300 minutes, about 360 minutes, about 420 minutes, or about 480 minutes. In some embodiments, the light is run every at least about 20 minutes, about 30 minutes, about 60 minutes, about 90 minutes, about 120 minutes, about 150 minutes, about 180 minutes, about 240 minutes, about 300 minutes, about 360 minutes, or about 420 minutes. In some embodiments, the light is run every at most about 30 minutes, about 60 minutes, about 90 minutes, about 120 minutes, about 150 minutes, about 180 minutes, about 240 minutes, about 300 minutes, about 360 minutes, about 420 minutes, or about 480 minutes.

In some embodiments, the light may be run for 1 second to 55 seconds. In some embodiments, the light may be run for 1 second to 5 seconds, 1 second to 10 seconds, 1 second to 15 seconds, 1 second to 20 seconds, 1 second to 25 seconds, 1 second to 30 seconds, 1 second to 35 seconds, 1 second to 40 seconds, 1 second to 45 seconds, 1 second to 50 seconds, 1 second to 55 seconds, 5 seconds to 10 seconds, 5 seconds to 15 seconds, 5 seconds to 20 seconds, 5 seconds to 25 seconds, 5 seconds to 30 seconds, 5 seconds to 35 seconds, 5 seconds to 40 seconds, 5 seconds to 45 seconds, 5 seconds to 50 seconds, 5 seconds to 55 seconds, 10 seconds to 15 seconds, 10 seconds to 20 seconds, 10 seconds to 25 seconds, 10 seconds to 30 seconds, 10 seconds to 35 seconds, 10 seconds to 40 seconds, 10 seconds to 45 seconds, 10 seconds to 50 seconds, 10 seconds to 55 seconds, 15 seconds to 20 seconds, 15 seconds to 25 seconds, 15 seconds to 30 seconds, 15 seconds to 35 seconds, 15 seconds to 40 seconds, 15 seconds to 45 seconds, 15 seconds to 50 seconds, 15 seconds to 55 seconds, 20 seconds to 25 seconds, 20 seconds to 30 seconds, 20 seconds to 35 seconds, 20 seconds to 40 seconds, 20 seconds to 45 seconds, 20 seconds to 50 seconds, 20 seconds to 55 seconds, 25 seconds to 30 seconds, 25 seconds to 35 seconds, 25 seconds to 40 seconds, 25 seconds to 45 seconds, 25 seconds to 50 seconds, 25 seconds to 55 seconds, 30 seconds to 35 seconds, 30 seconds to 40 seconds, 30 seconds to 45 seconds, 30 seconds to 50 seconds, 30 seconds to 55 seconds, 35 seconds to 40 seconds, 35 seconds to 45 seconds, 35 seconds to 50 seconds, 35 seconds to 55 seconds, 40 seconds to 45 seconds, 40 seconds to 50 seconds, 40 seconds to 55 seconds, 45 seconds to 50 seconds, 45 seconds to 55 seconds, or 50 seconds to 55 seconds. In some embodiments, the light may be run for 1 second, 5 seconds, 10 seconds, 15 seconds, 20 seconds, 25 seconds, 30 seconds, 35 seconds, 40 seconds, 45 seconds, 50 seconds, or 55 seconds. In some embodiments, the light may be run for at least 1 second, 5 seconds, 10 seconds, 15 seconds, 20 seconds, 25 seconds, 30 seconds, 35 seconds, 40 seconds, 45 seconds, or 50 seconds. In some embodiments, the light may be run for at most 5 seconds, 10 seconds, 15 seconds, 20 seconds, 25 seconds, 30 seconds, 35 seconds, 40 seconds, 45 seconds, 50 seconds, or 55 seconds. In some embodiments, the light may be run for about 60 seconds to about 170 seconds. In some embodiments, the light may be run for about 60 seconds to about 70 seconds, about 60 seconds to about 80 seconds, about 60 seconds to about 90 seconds, about 60 seconds to about 100 seconds, about 60 seconds to about 110 seconds, about 60 seconds to about 120 seconds, about 60 seconds to about 130 seconds, about 60 seconds to about 140 seconds, about 60 seconds to about 150 seconds, about 60 seconds to about 160 seconds, about 60 seconds to about 170 seconds, about 70 seconds to about 80 seconds, about 70 seconds to about 90 seconds, about 70 seconds to about 100 seconds, about 70 seconds to about 110 seconds, about 70 seconds to about 120 seconds, about 70 seconds to about 130 seconds, about 70 seconds to about 140 seconds, about 70 seconds to about 150 seconds, about 70 seconds to about 160 seconds, about 70 seconds to about 170 seconds, about 80 seconds to about 90 seconds, about 80 seconds to about 100 seconds, about 80 seconds to about 110 seconds, about 80 seconds to about 120 seconds, about 80 seconds to about 130 seconds, about 80 seconds to about 140 seconds, about 80 seconds to about 150 seconds, about 80 seconds to about 160 seconds, about 80 seconds to about 170 seconds, about 90 seconds to about 100 seconds, about 90 seconds to about 110 seconds, about 90 seconds to about 120 seconds, about 90 seconds to about 130 seconds, about 90 seconds to about 140 seconds, about 90 seconds to about 150 seconds, about 90 seconds to about 160 seconds, about 90 seconds to about 170 seconds, about 100 seconds to about 110 seconds, about 100 seconds to about 120 seconds, about 100 seconds to about 130 seconds, about 100 seconds to about 140 seconds, about 100 seconds to about 150 seconds, about 100 seconds to about 160 seconds, about 100 seconds to about 170 seconds, about 110 seconds to about 120 seconds, about 110 seconds to about 130 seconds, about 110 seconds to about 140 seconds, about 110 seconds to about 150 seconds, about 110 seconds to about 160 seconds, about 110 seconds to about 170 seconds, about 120 seconds to about 130 seconds, about 120 seconds to about 140 seconds, about 120 seconds to about 150 seconds, about 120 seconds to about 160 seconds, about 120 seconds to about 170 seconds, about 130 seconds to about 140 seconds, about 130 seconds to about 150 seconds, about 130 seconds to about 160 seconds, about 130 seconds to about 170 seconds, about 140 seconds to about 150 seconds, about 140 seconds to about 160 seconds, about 140 seconds to about 170 seconds, about 150 seconds to about 160 seconds, about 150 seconds to about 170 seconds, or about 160 seconds to about 170 seconds. In some embodiments, the light may be run for about 60 seconds, about 70 seconds, about 80 seconds, about 90 seconds, about 100 seconds, about 110 seconds, about 120 seconds, about 130 seconds, about 140 seconds, about 150 seconds, about 160 seconds, or about 170 seconds. In some embodiments, the light may be run for at least about 60 seconds, about 70 seconds, about 80 seconds, about 90 seconds, about 100 seconds, about 110 seconds, about 120 seconds, about 130 seconds, about 140 seconds, about 150 seconds, or about 160 seconds. In some embodiments, the light may be run for at most about 70 seconds, about 80 seconds, about 90 seconds, about 100 seconds, about 110 seconds, about 120 seconds, about 130 seconds, about 140 seconds, about 150 seconds, about 160 seconds, or about 170 seconds.

In some embodiments, the light is charged via inductive charging where a copper coil at the top of the pitcher 900 aligns with a copper coil at the top of the pitcher cavity in the water generator to charge a battery of the pitcher 900. In some embodiments, the wavelength of the UV light is 100 nanometers to 400 nanometers. In some embodiments, the wavelength of the UV light is about 100 nanometers to about 150 nanometers, about 100 nanometers to about 200 nanometers, about 100 nanometers to about 250 nanometers, about 100 nanometers to about 300 nanometers, about 100 nanometers to about 350 nanometers, about 100 nanometers to about 400 nanometers, about 150 nanometers to about 200 nanometers, about 150 nanometers to about 250 nanometers, about 150 nanometers to about 300 nanometers, about 150 nanometers to about 350 nanometers, about 150 nanometers to about 400 nanometers, about 200 nanometers to about 250 nanometers, about 200 nanometers to about 300 nanometers, about 200 nanometers to about 350 nanometers, about 200 nanometers to about 400 nanometers, about 250 nanometers to about 300 nanometers, about 250 nanometers to about 350 nanometers, about 250 nanometers to about 400 nanometers, about 300 nanometers to about 350 nanometers, about 300 nanometers to about 400 nanometers, or about 350 nanometers to about 400 nanometers. In some embodiments, the wavelength of the UV light is about 100 nanometers, about 150 nanometers, about 200 nanometers, about 250 nanometers, about 300 nanometers, about 350 nanometers, or about 400 nanometers. In some embodiments, the wavelength of the UV light is at least about 100 nanometers, about 150 nanometers, about 200 nanometers, about 250 nanometers, about 300 nanometers, or about 350 nanometers. In some embodiments, the wavelength of the UV light is at most about 150 nanometers, about 200 nanometers, about 250 nanometers, about 300 nanometers, about 350 nanometers, or about 400 nanometers.

In some embodiments, the UV light emits UV-A light. In some embodiments, the UV light emits UV-B light. In some embodiments, the UV light emits UV-C light. In some embodiments, the wavelength of the UV-C light is about 200 nanometers to about 280 nanometers. In some embodiments, the wavelength of the UV-C light is about 200 nanometers to about 210 nanometers, about 200 nanometers to about 220 nanometers, about 200 nanometers to about 230 nanometers, about 200 nanometers to about 240 nanometers, about 200 nanometers to about 250 nanometers, about 200 nanometers to about 260 nanometers, about 200 nanometers to about 270 nanometers, about 200 nanometers to about 280 nanometers, about 210 nanometers to about 220 nanometers, about 210 nanometers to about 230 nanometers, about 210 nanometers to about 240 nanometers, about 210 nanometers to about 250 nanometers, about 210 nanometers to about 260 nanometers, about 210 nanometers to about 270 nanometers, about 210 nanometers to about 280 nanometers, about 220 nanometers to ab out 230 nanometers, about 220 nanometers to about 240 nanometers, about 220 nanometers to about 250 nanometers, about 220 nanometers to about 260 nanometers, about 220 nanometers to about 270 nanometers, about 220 nanometers to about 280 nanometers, about 230 nanometers to about 240 nanometers, about 230 nanometers to about 250 nanometers, about 230 nanometers to about 260 nanometers, about 230 nanometers to about 270 nanometers, about 230 nanometers to about 280 nanometers, about 240 nanometers to about 250 nanometers, about 240 nanometers to about 260 nanometers, about 240 nanometers to about 270 nanometers, about 240 nanometers to about 280 nanometers, about 250 nanometers to about 260 nanometers, about 250 nanometers to about 270 nanometers, about 250 nanometers to about 280 nanometers, about 260 nanometers to about 270 nanometers, about 260 nanometers to about 280 nanometers, or about 270 nanometers to about 280 nanometers. In some embodiments, the wavelength of the UV-C light is about 200 nanometers, about 210 nanometers, about 220 nanometers, about 230 nanometers, about 240 nanometers, about 250 nanometers, about 260 nanometers, about 270 nanometers, or about 280 nanometers. In some embodiments, the wavelength of the UV-C light is at least about 200 nanometers, about 210 nanometers, about 220 nanometers, about 230 nanometers, about 240 nanometers, about 250 nanometers, about 260 nanometers, or about 270 nanometers. In some embodiments, the wavelength of the UV-C light is at most about 210 nanometers, about 220 nanometers, about 230 nanometers, about 240 nanometers, about 250 nanometers, about 260 nanometers, about 270 nanometers, or about 280 nanometers.

In some embodiments, the pitcher 900 may comprise a light sensor (located, e.g., on the pitcher 900 or on the housing of the water generator) to determine whether the UV light 1005 on the lid of the pitcher 900 is operable. In some embodiments, the light sensor is a UV-C LED sensor. In some embodiments, the light sensor alerts a user when the UV light on the lid portion of the pitcher 900 is low on battery, out of battery, or otherwise inoperable. In some embodiments, the light sensor uses UV circuits to determine whether the UV light is operating. In some embodiments, the pitcher 900 may comprise an alarm that generates an alert when the UV light is detected by the UV-C light sensor to have degraded performance. In some embodiments, the alarm is located in the pitcher 900, the housing of the water generator, or both.

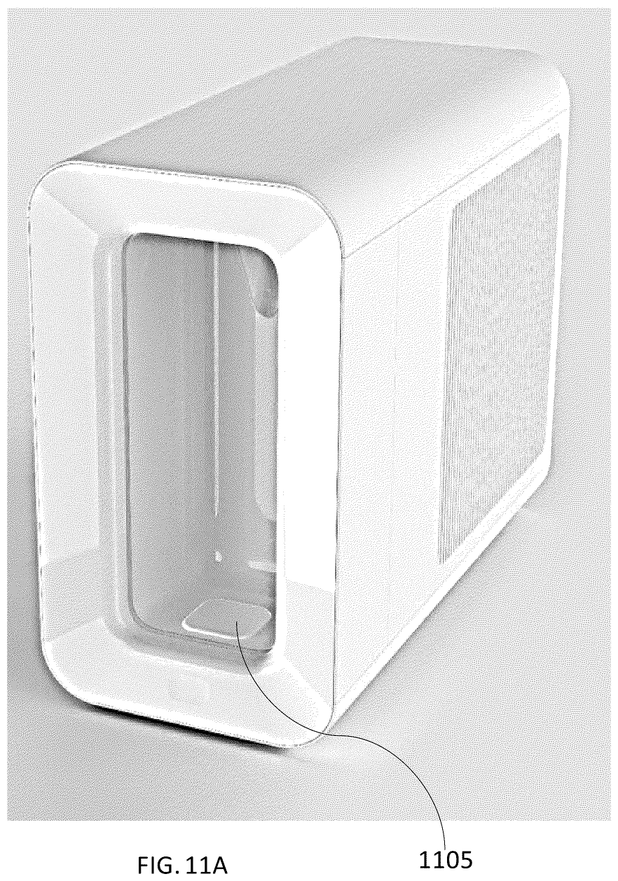

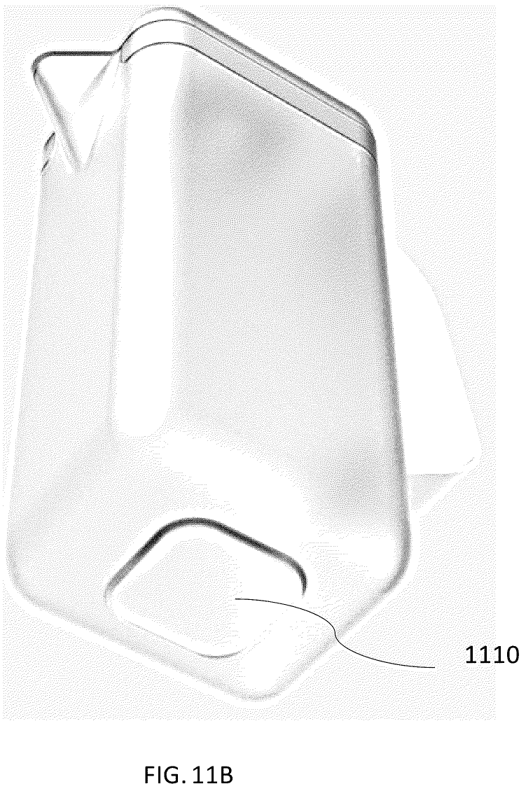

In some embodiments, the pitcher 900 may comprise an indent 1110 on the bottom of the body portion of the pitcher 900. In some embodiments, the pitcher cavity of the water generator may comprise an indent portion 1105 that substantially matches the indent portion of the pitcher 900 so that, when placed in the pitcher cavity, the pitcher 900 is secured in place. FIGS. 11A and 11B show non-limiting examples of the indent portion of the pitcher 1110 and the indent portion of the pitcher cavity 1105 of the water generator.

In some embodiments, the pitcher 900 further comprises a pitcher sensor (not shown). In some embodiments, the pitcher sensor determines whether the pitcher 900 is in the pitcher cavity of the water generator device. In some embodiments, where the sensor determines that the pitcher 900 is not present in the pitcher cavity of the water generator device, the sensor communicates to the water generator device not to output water into the pitcher cavity thereby preventing spillage of water. In some embodiments, the pitcher sensor is a hall effect sensor. In some embodiments, the hall effect sensor is located in the pitcher cavity and a magnet (e.g., neodymium) is located in the pitcher 900. In some embodiments, the pitcher sensor is an infrared (IR) sensor configured with a transmitter and receiver to detect proximity of a surface (e.g., the body of the pitcher). In some embodiments, the infrared sensor is an infrared distance sensor.

In some embodiments, the pitcher 900 further comprises a water sensor (not shown). In some embodiments, the water sensor is located in the pitcher cavity of the water generator. In some embodiments, the water sensor determines a water level in the pitcher 900 through a wall of the pitcher. If the water level is below a predetermined threshold (e.g., the water tank is empty or partially filled) the water generator may automatically run until the water level in the pitcher 900 rises to the predetermined threshold (e.g., the pitcher 900 is filled). In some embodiments, the water sensor is a top-down ultrasound sensor. In some embodiments, the water sensor is an ultrasonic distance sensor. In some embodiments, an ultrasonic water sensor allows for non-contact sensing of the water level and accurate determination of the water level. In some embodiments, the water sensor is a float sensor. In some embodiments, the water sensor is a laser sensor, an optical sensor, a photoelectric sensor, an electric sensor, pressure sensor, a weight sensor, or another suitable sensor type for determining a water level.

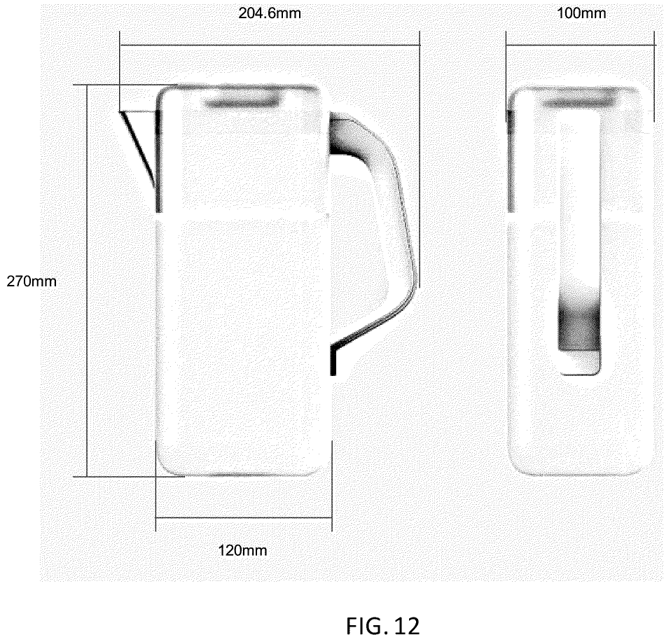

FIG. 12 depicts non-limiting external views of the pitcher 900 with non-limiting dimensions. In some embodiments, the pitcher 900 comprises a height of about 270 mm, a width of about 120 mm excluding the spout and the handle of the pitcher, a width of about 205 mm including the spout and the handle of the pitcher, and a depth of about 100 mm.

In some embodiments, filtered water from the filter cartridge 130 is output into a second water reservoir (e.g., a pitcher, a cooler, a thermos, a bottle, etc.) or water collection tank 135. In some embodiments, the water collection tank 135 is a half-gallon tank, a gallon tank, a 1.5 gallon tank, or some other suitable size. In some large scale embodiments of the device (e.g., a water tower) the water collection tank 135 may be larger, such as, 500 gallons. In some embodiments, a pipe, tube, or fluid conduit is provided to transport the water from the filter into the collection tank 135. In some embodiments, the collection tank 135 is removable. In some embodiment, the collection tank 135 is in fluid communication with a waterspout or outflow 140. In some embodiments, the portable water generator comprises a button to activate a second pump 137 to dispense fluid from the device. In some embodiments, the water collection tank 135 comprises a two-way valve 138 which allows water in the collection tank 135 to be in fluid communication with the second pump when the collection tank 135 is seated within the device, but prevents water from leaking when the collection tank 135 is removed from the device.

In some embodiments, the water generator further comprises a water level sensor 139. In some embodiments, the water level sensor 139 monitors the water level in the collection tank 135. If the water level is below a predetermined threshold (e.g., the water tank is empty or partially filled) the water generator may automatically run until the water level in the collection tank rises to the predetermined threshold (e.g., the water tank is filled). In some embodiments, when the water level is below a predetermined threshold the water in the collection tank 135 may not be pumped out of the water collection tank 135 (e.g., to reduce gurgling sounds and improve overall quietness). In some embodiments, the water level sensor 139 is an ultrasonic distance sensor. In some embodiments, an ultrasonic water sensor allows for non-contact sensing of the water level and accurate determination of the water level. In some embodiments, the water level sensor is a laser sensor, an optical sensor, a photoelectric sensor, an electric sensor, pressure sensor, a weight sensor, or another suitable sensor type for determining a water level.

### Example Methods and Processes

With reference to FIG. 1B, a method of generating potable water from the atmosphere is depicted. The reference numerals provided in FIG. 1B (e.g., numerals 1-6) correspond to the numerals provided in FIG. 1A which depict the location at which the method operation takes place.

In some embodiments, with reference to FIGS. 1A and 1B, a method for generating water from the atmosphere comprises a first operation 1 wherein fresh filtered air passes through the desiccant core. In some embodiments, the desiccant core becomes saturated with water vapor as the air passes through it.

In some embodiments, at a second operation 2, a portion of the desiccant core is heated and an air flow from the fan provided within the water generator pushes water vapor from the desiccant wheel and into the condensing unit. In some embodiments, the desiccant core is a wheel or disc which spins as a portion of it is heated. Such a configuration may prevent portions of the desiccant core from overheating. In some embodiments, one-quarter of a desiccant wheel is heated as it spins. In some embodiments, the desiccant wheel spins at about 1 rotation per minute (RPM). In some embodiments, the desiccant wheel rotates at about 0.5 RPM to about 30 RPM. In some embodiments, the desiccant wheel rotates at about 0.5 RPM to about 1 RPM, about 0.5 RPM to about 2 RPM, about 0.5 RPM to about 3 RPM, about 0.5 RPM to about 5 RPM, about 0.5 RPM to about 10 RPM, about 0.5 RPM to about 20 RPM, about 0.5 RPM to about 30 RPM, about 1 RPM to about 2 RPM, about 1 RPM to about 3 RPM, about 1 RPM to about 5 RPM, about 1 RPM to about 10 RPM, about 1 RPM to about 20 RPM, about 1 RPM to about 30 RPM, about 2 RPM to about 3 RPM, about 2 RPM to about 5 RPM, about 2 RPM to about 10 RPM, about 2 RPM to about 20 RPM, about 2 RPM to about 30 RPM, about 3 RPM to about 5 RPM, about 3 RPM to about 10 RPM, about 3 RPM to about 20 RPM, about 3 RPM to about 30 RPM, about 5 RPM to about 10 RPM, about 5 RPM to about 20 RPM, about 5 RPM to about 30 RPM, about 10 RPM to about 20 RPM, about 10 RPM to about 30 RPM, or about 20 RPM to about 30 RPM. In some embodiments, the desiccant wheel rotates at about 0.5 RPM, about 1 RPM, about 2 RPM, about 3 RPM, about 5 RPM, about 10 RPM, about 20 RPM, or about 30 RPM. In some embodiments, the desiccant wheel rotates at least about 0.5 RPM, about 1 RPM, about 2 RPM, about 3 RPM, about 5 RPM, about 10 RPM, or about 20 RPM. In some embodiments, the desiccant wheel rotates at most about 1 RPM, about 2 RPM, about 3 RPM, about 5 RPM, about 10 RPM, about 20 RPM, or about 30 RPM. In some embodiments, the rotation speed of the desiccant wheel is based on a measured temperature and/or humidity.

In some embodiments, at a third operation 3, hot damp air is circulated through the condensing unit. In some embodiments, an additional fan is provided to provide airflow to circulate the air through the condensing unit.

In some embodiments, at a fourth operation 4, the damp airflow is cooled within the condensing unit and the water vapor condenses into droplets which collect. In some embodiments, the condensing unit is cooled with ambient air to allow condensation of water vapor within the airflow.

In some embodiments, at a fifth operation 5, water is accumulated in a first reservoir. In some embodiments, the accumulated water is immediately filtered. In some embodiments, the filtration includes alkalization.

In some embodiments, at a sixth operation 6, the filtered water accumulates in a second reservoir or water collection tank, where it is stored until it is dispensed.

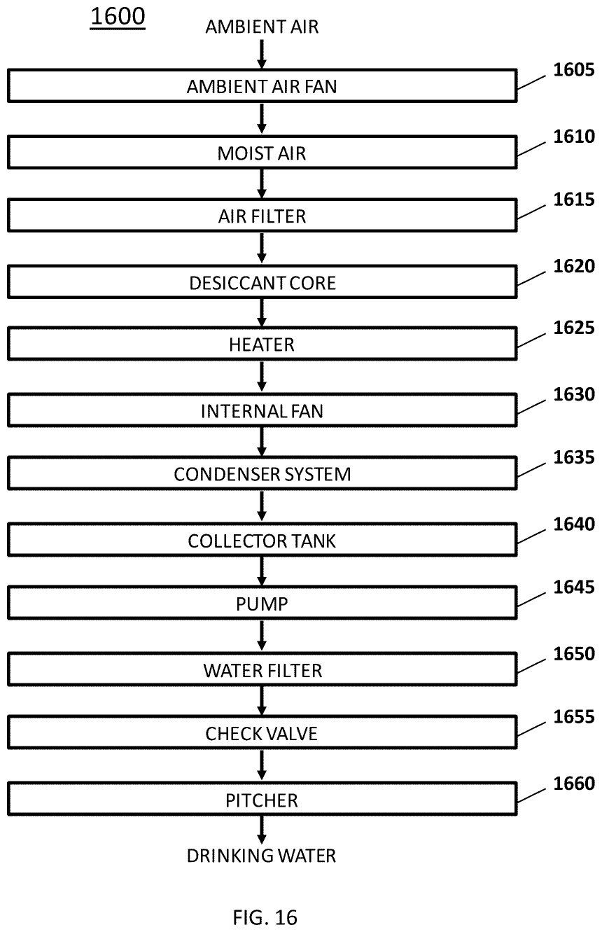

FIG. 16 depicts a non-limiting example of a process 1600 for generating drinking water, according to some embodiments. The process 1600 may include using an ambient air fan at 1605 to move ambient air as moist air at 1610 into an air filter at 1615, thereby generating filtered air. The filtered air may pass through a desiccant core at 1620, a heater at 1625, an internal fan at 1630, and a condenser system at 1635, thereby generated condensed water. The condensed water may be collected at a collector tank at 1640 and pumped at 1645 to a water filter at 1650, thereby generating filtered water. The filtered water may pass through a check valve at 1655 and into a pitcher at 1660. One or more of these operations in the process 1600 may be repeated (e.g., iteratively), omitted, or performed in any order, depending on application.

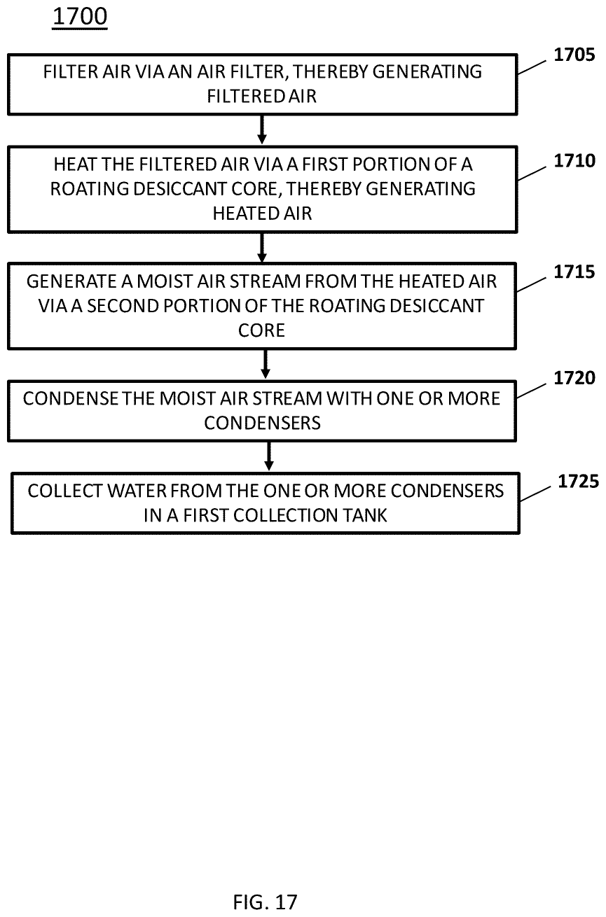

FIG. 17 depicts a non-limiting example of a method 1700 for generating water from atmospheric conditions, according to some embodiments. The method may include (A) filtering air via an air filter, thereby generating filtered air (block 1705); (B) heating the filtered air via a first portion of a rotating desiccant core, thereby generating heated air (block 1710); (C) generating a moist air stream from the heated air via a second portion of the rotating desiccant core (block 1715); (D) condensing the moist air stream with one or more condensers (block 1720); and (E) collecting water from the one or more condensers in a first collection tank (block 1725).

In some embodiments, the method 1700 may further include filtering the water, via a water filter, collected from the one or more condensers at block 1725. In some embodiments, the method 1700 may further include collecting the water in a pitcher after filtering the water. In some embodiments, the method 1700 may further include monitoring a water level or a water amount of the water within one or both of the first collection tank or the pitcher. In some embodiments, the method 1700 may further include adding one or more minerals to the water. In some embodiments, the method 1700 may include adding one or more flavorings to the water. In some embodiments, the method 1700 may include brewing coffee or tea from the water. In some embodiments, the method 1700 may include chilling the water. In some embodiments, the method 1700 may include heating the water. In some embodiments, the method 1700 may include watering a plant with the water or providing the water to an animal. In some embodiments, the method 1700 may include storing operation data, wherein the operation data comprises one or more of: a volume of the water collected, a total operation time for collecting the water, a temperature of the air, or a humidity of the air. In some embodiments, the method 1700 may include transmitting the operation data (e.g., wherein the operation data is transmitted to a wireless controller such as a user device). In some embodiments, the method 1700 may include generating one or more alerts (e.g., an indication to replace a water filter, an indication to replace the air filter, a system malfunction, a low water level or water amount of the water within one or both of the first collection tank or the pitcher, or a high water level or water amount of the water within one or both of the first collection tank or the pitcher) based on the operation data.

### Example Filter Cartridge

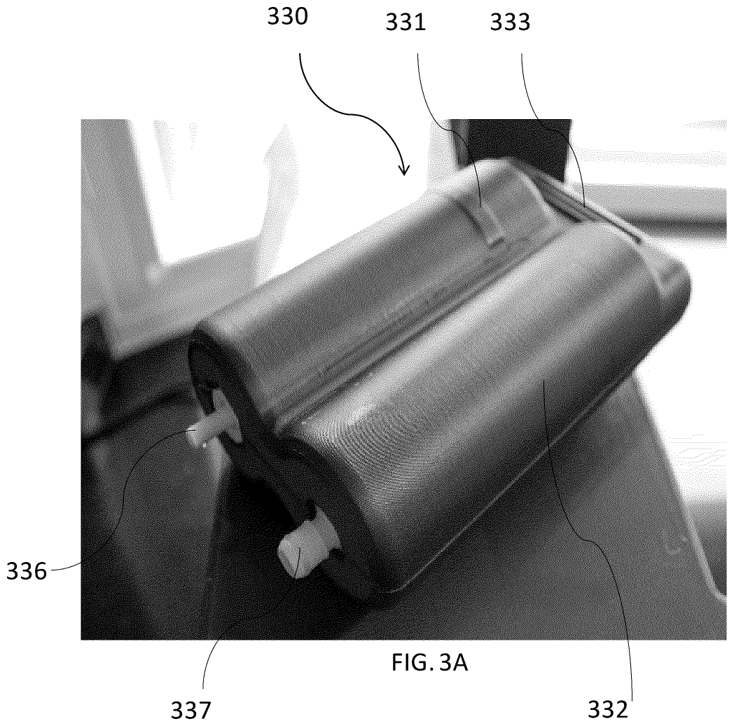

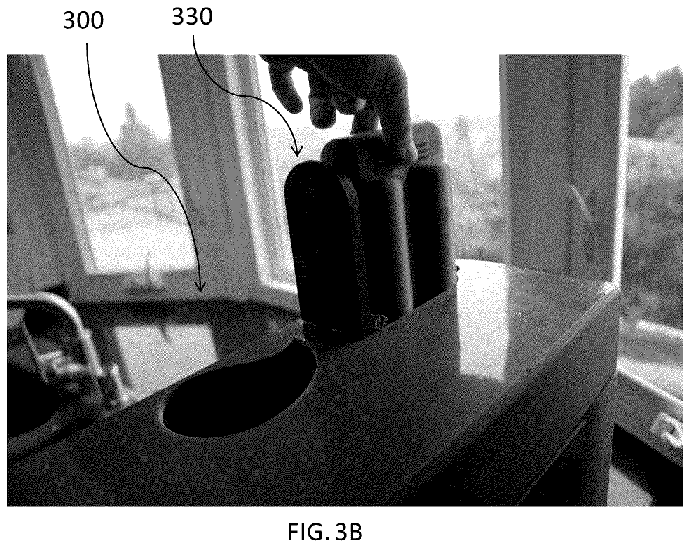

In some embodiments, the portable water generator comprises a filter cartridge. In some embodiments, with reference to FIGS. 3A and 3B, a filter cartridge 330 is removable from the portable water generator 300 to facilitate replacement. In some embodiments, the filter cartridge 330 fits within the water generator 300 by a friction or tight-tolerance fit. In some embodiments, the portable water generator 300 comprises a button to actuate a latch to release the filter cartridge 330. In some embodiments, the housing comprises a hatch. In some embodiments, the hatch is able to be closed only when the filter cartridge 330 is fully seated, thereby preventing operation of the device without the filter cartridge 330 in place. In some embodiments, the water generator 300 comprises a sensor configured deactivate the generator if the cartridge is not fully seated or if the hatch is not fully closed. FIG. 3B depicts the removal of the filter cartridge 330 from the portable water generator 300.

In some embodiments, the filter cartridge 330 comprises a radio frequency identification (RFID) tag (or some other suitable identifier or sensor). In some embodiments, the RFID tag is used to determine the length of time that the filer cartridge 330 has been in the portable water generator 300. In some embodiments, the RFID tag is used to communicate to a user that the filter cartridge 330 has been in the portable water generator 300 for too long (e.g., one month or longer, two months or longer, three months or longer, four months or longer, five months or longer, six months or longer, etc.), indicating to a user to replace the filter cartridge 330. In some embodiments, the RFID tag is used to disable the portable water generator 300 if the water filter has been in the portable water generator for too long. In some embodiments, the RFID tag is used to determine that the filter cartridge 330 is in the portable water generator 300. In some embodiments, when the RFID tag determines that the filter cartridge 330 is not in the portable water generator 300, the RFID tag disables the portable water generator 300, preventing spillage of water.

In some embodiments, an RFID tag may be implemented with the air filter that may be used in the same as or similar ways as the RFID tag is used with the water filter. In some embodiments, other techniques may be used to achieve the same or similar benefits and effects as the RFID tag. For example, in some embodiments, barcodes may be used in addition or in alternative to the RFID tag. Barcodes are a simple, cost-effective, and widely adopted method for tracking and identifying products. Barcodes are easy to generate and print, but may use line-of-sight scanning, which can be less efficient compared to RFID. In another example, in some embodiments, quick response (QR) codes may be used in addition or in alternative to the RFID tag. QR codes are a type of 2D barcode that can store more information than traditional barcodes. QR codes can be scanned with smartphones or dedicated scanning devices and can include data such as URLs or other information. In another example, in some embodiments, near field communications (NFC) may be used in addition or in alternative to the RFID tag. NFC is a short-range wireless communication technology that allows devices to exchange data when in close proximity (up to a few centimeters). NFC tags can be used for contactless payments, access control, and data sharing. In another example, in some embodiments, Bluetooth low energy (BLE) beacons may be used in addition or in alternative to the RFID tag. BLE beacons are small devices that transmit a unique identifier using Bluetooth Low Energy technology. BLE beacons can be used for indoor positioning, asset tracking, and proximity-based services. In another example, in some embodiments, ultra-wideband (UWB) tags may be used in addition or in alternative to the RFID tag. In another example, in some embodiments, UWB tags may be used in addition or in alternative to the RFID tag. UWB is a wireless communication technology that can provide highly accurate positioning and data transfer over short distances. UWB tags can be used for real-time location tracking and inventory management. In another example, in some embodiments, computer vision techniques may be used in addition or in alternative to the RFID tag. Computer vision techniques, such as image recognition and object tracking, can be used to identify and track objects without the need for physical tags. This can be especially useful in situations where attaching a tag is not feasible or desirable. In another example, in some embodiments, acoustic tags may be used in addition or in alternative to the RFID tag. Acoustic Tags: Acoustic tags emit sound waves that can be detected by specialized receivers. Acoustic tags may be used when radio frequency-based technologies may be less effective. In another example, in some embodiments, magnetic tags may be used in addition or in alternative to the RFID tag. Magnetic tags use magnetic fields to store and transmit data and can be used in environments where RF signals are not effective.

In some embodiments, as depicted in FIG. 3A, the filter cartridge 330 comprises an inlet 336 for receiving water from a fluid conduit. In some embodiments, water from the fluid conduit is pumped into the inlet 336. In some embodiments, the filter cartridge 330 is a two-stage filter comprising a first filter 331 and a second filter 332. In some embodiments, the inlet 336 feeds into a first filter 331 of the filter cartridge 330. In some embodiments, the first filter 331 is configured to purify the water, making the water potable. In some embodiments, the first filter 331 is configured for water purification. In some embodiments, the first filter 331 is a carbon filter, a membrane filter, an ultraviolet (UV) light filter or any other filter type suitable for the purification of water. In some embodiments, the first filter 331 is an Argonide filter. In some embodiments, the first filter 331 is an Argonide NanoCeram filter. In some embodiments, the first filter 331 is a hollowfiber filter. In some embodiments, the first filter 331 is any type of filter suitable for particle filtering. In some embodiments, the first filter 331 is a pleated filter. In some embodiments, the first filter 331 comprises a non-woven filter media matrix. In some embodiments, the first filter 331 comprises a non-woven filter media matrix infused with nanoalumina fibers. In some embodiments, the first filter 331 comprises a microglass fibers and cellulose. In some embodiments, the first filter 331 comprises a non-woven filter media matrix of microglass fibers and cellulose infused with nanoalumina fibers.

In some embodiments, the filter cartridge 330 further comprises a second filter 332. In some embodiments, the second filter 332 receives the purified water from the first filter 331. In some embodiments, the purified water is provided from the first filter 331 to the second filter 332 via a fluid conduit 333. In some embodiments, the second filter 332 is provided to add minerals (e.g., remineralization) to the purified water received from the first filter 331. In some embodiments, the added minerals comprise magnesium. In some embodiments, the added minerals comprise carbon. In some embodiments, the added minerals comprise sodium. In some embodiments, the added minerals comprise potassium. In some embodiments, the added minerals comprise manganese. In some embodiments, the added minerals comprise iron. In some embodiments, the second filter 332 is an alkaline filter. In some embodiments, the first filter 331 and second filter 332 are provided such that the water is first mineralized, then the water is purified. In some embodiments, the filter cartridge 330 comprises and outlet 337 to provide the filtered and treated water. In some embodiments, the filtered and treated water from the cartridge is provided to a second reservoir or water collection tank, as disclosed herein.

In some embodiments, flavoring may be added to the water. In some embodiments, the flavoring may comprise a powder (e.g., sugar), a gel, or a liquid (e.g., syrup). In some embodiments, the flavoring may comprise fruit or a fruit product to generate, e.g., spa water. In some embodiments, the flavoring may comprise tea. In some embodiments, the flavoring may comprise coffee. The flavoring may be added, in some embodiments, during filtering of the water (e.g., during the remineralization stage) or after filtering the water (e.g., while the water is in the pitcher). In some embodiments, such as when the flavoring comprises coffee or tea, the water may be heated by a water heater before being used to brew the coffee or the tea using a coffee unit or a tea unit. In some embodiments, the water may be chilled using a water chiller. In some embodiments, the water may be carbonated using a water carbonation unit.

### Controller

In some embodiments, the portable atmospheric water generator comprises at least one controller for controlling operations of the electronic components within the device. In some embodiments, the controller comprises a CPU with instructions for timing the activation of the device and its components. In some embodiments, the controller wirelessly communicates with a user device to allow a user to activate the water generator or set threshold for the water generator. In some embodiments, the user sets a threshold for the minimum relative humidity level at which the device will operate. In some embodiments, the controller provides the user with information such as how much water will be generated per unit of time or how much electricity is required to generate a volume of water at the current ambient conditions surrounding the water generator. The user may use this information to set thresholds such that the device operates efficiently. In some embodiments, the device will operate at default thresholds, such as a default relative humidity level.

In some embodiments, the controller further comprises components to allow for wireless communication with an external device, such as a smart device of a user. In some embodiments, the controller provides information regarding the status of the device, such as the water level of the collection tank and if the device is currently running. In some embodiments, the controller wirelessly transmits information related to the ambient conditions surrounding the device, such as the temperature and relative humidity. The controller may further communicate lifetime statistics of the device, such as total water generated, average humidity operated, electricity consumed per volume of water generated, average water generated per unit of time, etc.

### Example Periodic Subscription Model

In some embodiments, the portable atmospheric water generator comprises a controller with a wireless communication system. In some embodiments, the wireless communication system couples to a Wi-Fi, cellular, or satellite network. In some embodiments, wireless connection of the water generator to a network allows for remote control of the water generator.

In some embodiments, a subscription payment model is implemented to control the function of the water generator. In some embodiments, the subscription model includes shipping of replacement filters for the water generator. In some embodiments, the subscription model further includes shipping materials for receiving used filters and components of the water generator from a customer for disposal, recycling, and/or renewal.

In some embodiments, the water generator is remotely deactivated if a customer does not pay the required the subscription fees or replace the filters. This may prevent a customer from drinking contaminated water due to an expired filter. In an example, a user may pay a subscription fee periodically. The payment period may be weekly, quarterly, semi-annually, annually, bi-annually, or of increments therebetween. In some embodiments, payment is required when a filter has expired. For example, in some embodiments, a water filter of the device lasts for one year before it needs to be replaced. In said example, the customer will need to pay a subscription fee annually to receive a replacement filter and/or keep their water generator from being deactivated.

Computing system

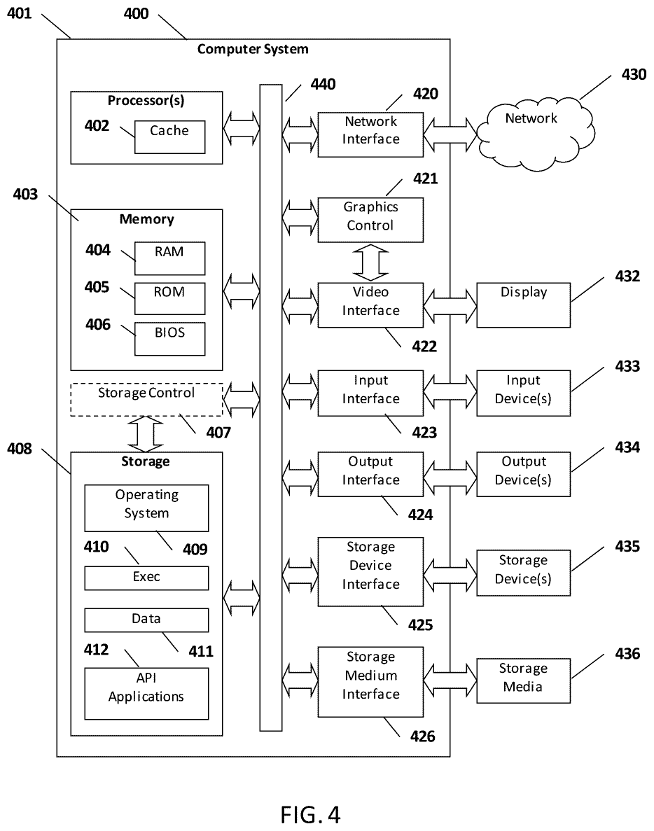

Referring to FIG. 4, a block diagram is shown depicting an exemplary machine that includes a computer system 400 (e.g., a processing or computing system) within which a set of instructions can execute for causing a device to perform or execute any one or more of the aspects and/or methodologies for static code scheduling of the present disclosure. The components in FIG. 4 are examples only and do not limit the scope of use or functionality of any hardware, software, embedded logic component, or a combination of two or more such components implementing particular embodiments.

Computer system 400 may include one or more processors 401, a memory 403, and a storage 408 that communicate with each other, and with other components, via a bus 440. The bus 440 may also link a display 432, one or more input devices 433 (which may, for example, include a keypad, a keyboard, a mouse, a stylus, etc.), one or more output devices 434, one or more storage devices 435, and various tangible storage media 436. All of these elements may interface directly or via one or more interfaces or adaptors to the bus 440. For instance, the various tangible storage media 436 can interface with the bus 440 via storage medium interface 426. Computer system 400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 400 includes one or more processor(s) 401 (e.g., central processing units (CPUs), general purpose graphics processing units (GPGPUs), or quantum processing units (QPUs)) that carry out functions. Processor(s) 401 optionally contains a cache memory unit 402 for temporary local storage of instructions, data, or computer addresses. Processor(s) 401 are configured to assist in execution of computer readable instructions. Computer system 400 may provide functionality for the components depicted in FIG. 4 as a result of the processor(s) 401 executing non-transitory, processor-executable instructions embodied in one or more tangible computer-readable storage media, such as memory 403, storage 408, storage devices 435, and/or storage medium 436. The computer-readable media may store software that implements particular embodiments, and processor(s) 401 may execute the software. Memory 403 may read the software from one or more other computer-readable media (such as mass storage device(s) 435, 436) or from one or more other sources through a suitable interface, such as network interface 420. The software may cause processor(s) 401 to carry out one or more processes or one or more operations of one or more processes described or illustrated herein. Carrying out such processes or operations may include defining data structures stored in memory 403 and modifying the data structures as directed by the software.

The memory 403 may include various components (e.g., machine readable media) including, but not limited to, a random access memory component (e.g., RAM 404) (e.g., static RAM (SRAM), dynamic RAM (DRAM), ferroelectric random access memory (FRAM), phase-change random access memory (PRAM), etc.), a read-only memory component (e.g., ROM 405), and any combinations thereof. ROM 405 may act to communicate data and instructions unidirectionally to processor(s) 401, and RAM 404 may act to communicate data and instructions bidirectionally with processor(s) 401. ROM 405 and RAM 404 may include any suitable tangible computer-readable media described below. In one example, a basic input/output system 406 (BIOS), including basic routines that help to transfer information between elements within computer system 400, such as during start-up, may be stored in the memory 403.

Fixed storage 408 is connected bidirectionally to processor(s) 401, optionally through storage control unit 407. Fixed storage 408 provides additional data storage capacity and may also include any suitable tangible computer-readable media described herein. Storage 408 may be used to store operating system 409, executable(s) 410, data 411, applications 412 (application programs), and the like. Storage 408 can also include an optical disk drive, a solid-state memory device (e.g., flash-based systems), or a combination of any of the above. Information in storage 408 may, in appropriate cases, be incorporated as virtual memory in memory 403.

In one example, storage device(s) 435 may be removably interfaced with computer system 400 (e.g., via an external port connector (not shown)) via a storage device interface 425. Particularly, storage device(s) 435 and an associated machine-readable medium may provide non-volatile and/or volatile storage of machine-readable instructions, data structures, program modules, and/or other data for the computer system 400. In one example, software may reside, completely or partially, within a machine-readable medium on storage device(s) 435. In another example, software may reside, completely or partially, within processor(s) 401.

Bus 440 connects a wide variety of subsystems. Herein, reference to a bus may encompass one or more digital signal lines serving a common function, where appropriate. Bus 440 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 400 may also include an input device 433. In one example, a user of computer system 400 may enter commands and/or other information into computer system 400 via input device(s) 433. Examples of an input device(s) 433 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 433 may be interfaced to bus 440 via any of a variety of input interfaces 423 (e.g., input interface 423) including, but not limited to, serial, parallel, game port, USB, FIREWIRE, THUNDERBOLT, or any combination of the above.

In particular embodiments, when computer system 400 is connected to network 430, computer system 400 may communicate with other devices, specifically mobile devices and enterprise systems, distributed computing systems, cloud storage systems, cloud computing systems, and the like, connected to network 430. Communications to and from computer system 400 may be sent through network interface 420. For example, network interface 420 may receive incoming communications (such as requests or responses from other devices) in the form of one or more packets (such as Internet Protocol (IP) packets) from network 430, and computer system 400 may store the incoming communications in memory 403 for processing. Computer system 400 may similarly store outgoing communications (such as requests or responses to other devices) in the form of one or more packets in memory 403 and communicated to network 430 from network interface 420. Processor(s) 401 may access these communication packets stored in memory 403 for processing.

Examples of the network interface 420 include, but are not limited to, a network interface card, a modem, and any combination thereof. Examples of a network 430 or network segment 430 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 430, may employ a wired and/or a wireless mode of communication. In general, any network topology may be used.

Information and data can be displayed through a display 432. Examples of a display 432 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 432 can interface to the processor(s) 401, memory 403, and fixed storage 408, as well as other devices, such as input device(s) 433, via the bus 440. The display 432 is linked to the bus 440 via a video interface 422, and transport of data between the display 432 and the bus 440 can be controlled via the graphics control 421. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 432, computer system 400 may include one or more other peripheral output devices 434 including, but not limited to, an audio speaker, a printer, a storage device, and any combinations thereof. Such peripheral output devices may be connected to the bus 440 via an output interface 424. Examples of an output interface 424 include, but are not limited to, a serial port, a parallel connection, a USB port, a FIREWIRE port, a THUNDERBOLT port, and any combinations thereof

In addition or as an alternative, computer system 400 may provide functionality as a result of logic hardwired or otherwise embodied in a circuit, which may operate in place of or together with software to execute one or more processes or one or more operations of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenB SD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® Web OS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, my SQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® Action Script, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

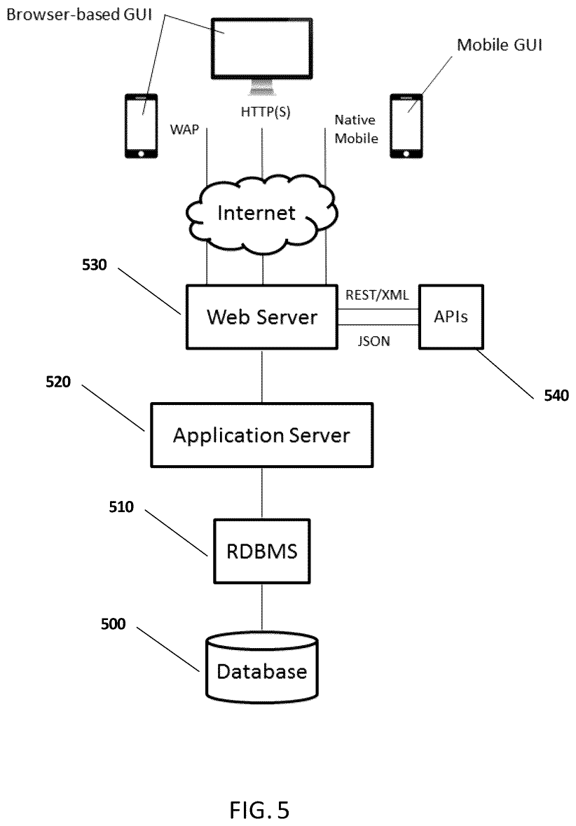

Referring to FIG. 5, in a particular embodiment, an application provision system comprises one or more databases 500 accessed by a relational database management system (RDBMS) 510. Suitable RDBMSs include Firebird, My SQL, PostgreSQL, SQLite, Oracle Database, Microsoft SQL Server, IBM DB2, IBM Informix, SAP Sybase, Teradata, and the like. In this embodiment, the application provision system further comprises one or more application severs 520 (such as Java servers, .NET servers, PHP servers, and the like) and one or more web servers 530 (such as Apache, IIS, GWS and the like). The web server(s) optionally expose one or more web services via app application programming interfaces (APIs) 540. Via a network, such as the Internet, the system provides browser-based and/or mobile native user interfaces.

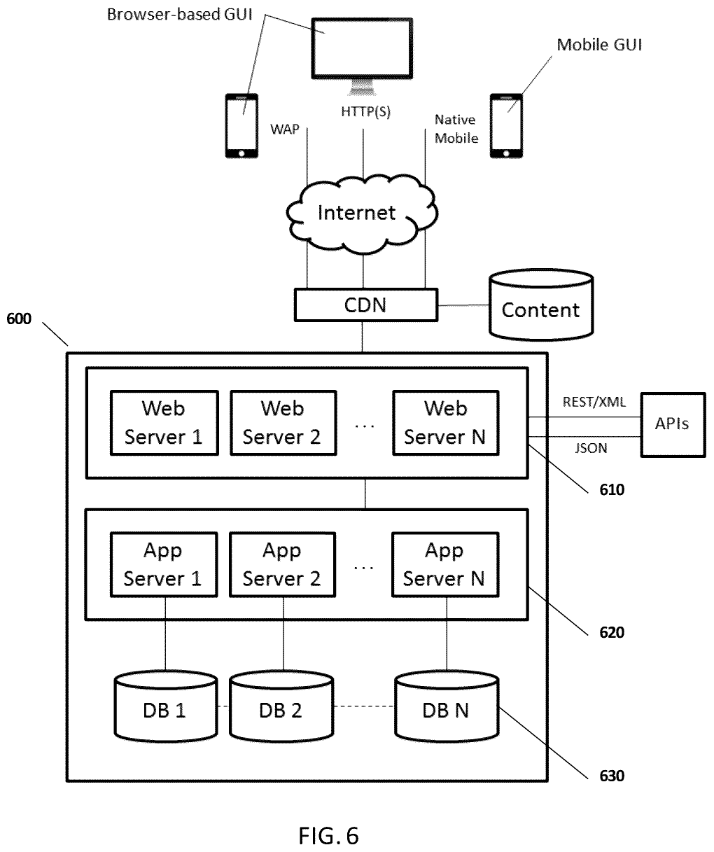

Referring to FIG. 6, in a particular embodiment, an application provision system alternatively has a distributed, cloud-based architecture 600 and comprises elastically load balanced, auto-scaling web server resources 610 and application server resources 620 as well synchronously replicated databases 630.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, Airplay SDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, Mo Sync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™ PHP, Python™, and VB.NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of information related to a subject, nucleic acid sequence, epigenetic, activity, survey, demographic, medical record, glucose monitoring data, transcriptomic data, proteomic data, metabolomic, and health prediction information. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, My SQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### Certain Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including mixtures thereof.

As used herein, the term “about” a number refers to that number plus or minus 10% of that number. The term “about” a range refers to that range minus 10% of its lowest value and plus 10% of its greatest value.

The section headings used herein are for organizational purposes only and are not to be construed as limiting the subject matter described.

1. A system for atmospheric water generation, comprising:
(A) a dehumidifier configured to receive air, comprising:
(i) a desiccant core,
(ii) a heater configured to heat at least a portion of the desiccant core, and
(iii) a condenser system configured to collect water from the desiccant core when the desiccant core is heated by the heater; and
(B) a fluid filter configured to filter one or both of (i) the air, prior to the dehumidifier receiving the air, or (ii) the water, after the water is collected by the condenser system.

2. The system of claim 1, further comprising a pitcher configured to hold the water.

3. The system of claim 2, wherein the pitcher comprises an ultraviolet (UV) light that is configured to direct ultraviolet-C (UV-C) light towards the water in the pitcher and cycle between a powered-on state and a powered-off state at a first frequency.

4. The system of claim 3, wherein the first frequency is between 5 minutes and 120 minutes.

5. The system of claim 2, further comprising one or more sensors configured to determine a water level or a water amount in the pitcher, and wherein one or both of the dehumidifier or the fluid filter are configured to disable in response to the water level or the water amount in the pitcher satisfying a threshold.

6. The system of claim 1, wherein the condenser system comprises:
a first collection tank configured to collect the water from the desiccant core when the desiccant core is heated by the heater; and
a first pump in fluid connection with the first collection tank.

7. The system of claim 6, wherein the first pump is configured to pump the water from the first fluid collection tank into a pitcher via a water outflow.

8. The system of claim 7, further comprising one or more sensors configured to determine a water level or a water amount in the first collection tank and wherein the first pump is configured to pump the water from the first fluid collection tank into the pitcher when the water level or the water amount in the first collection tank satisfies a threshold.

9. The system of claim 8, wherein one or both of the dehumidifier or the fluid filter are configured to disable in response to the water level or the water amount in the first collection tank satisfying a threshold.

10. The system of claim 1, wherein the fluid filter comprises an air filter configured to filter the air and a water filter configured to filter the water.

11. The system of claim 10, further comprising an air quality sensor configured to monitor air quality of the air at one or both of a time (i) before the air is filtered by the air filter, or (ii) after the air is filtered by the air filter.

12. The system of claim 10, wherein the water filter comprises a filter cartridge that is removable from the fluid filter and is configured to perform a two-stage filtration process, and wherein the filter cartridge comprises a first filter and a second filter that is in fluid connection to the first filter.

13. The system of claim 12, wherein the first filter is configured to perform particle filtration of the water and the second filter is configured to perform remineralization of the water after the water is filtered by the first filter.

14. The system of claim 12, further comprising one or more sensors configured to determine, via a radio-frequency identification (RFID) tag on the filter cartridge, (i) whether the filter cartridge is present in the fluid filter and (ii) a length of time that the filter cartridge has been present in the fluid filter.

15. The system of claim 1, wherein the condenser system comprises one or more tube condensers that comprise one or more of plastic, ceramic, glass, or metal.

16. The system of claim 1, wherein the desiccant core comprises one or more of: silica, activated charcoal, calcium sulfate, calcium chloride, activated alumina, zeolites, molecular sieves, or metal organic framework (MOF).

17. The system of claim 1, further comprising a computing device and a wireless network interface, wherein the computing device is configured to obtain operation data that comprises one or more of: a volume of the water generated by the dehumidifier over an elapsed time, a total volume of the water generated by the dehumidifier, a total operation time of the dehumidifier, temperature of the air, or humidity of the air.

18. The system of claim 17, wherein the wireless network interface is configured to wirelessly connect to a display device that comprises a display that presents the operation data and wherein the display device is configured to transmit instructions to the wireless network interface, wherein the instructions comprise an instruction to operate one or both of dehumidifier or the fluid filter until one or more parameters are satisfied.

19. The system of claim 1, further comprising a user control configured to set a power setting of one or both of the dehumidifier or the fluid filter, wherein the power setting comprises a first power level and a second power level, and wherein the first power level and the second power level each correspond to a different operational rate for one or both of the dehumidifier or the fluid filter.

20. The system of claim 1, further comprising one or both of a water chiller configured to cool the water or a water heater configured to heat the water.

21. The system of claim 1, further comprising one or more of: a water flavoring unit configured to add a flavor to the water, a water carbonating unit configured to add carbonation to the water, a tea unit configured to generate tea using at least the water, or a coffee unit configured to generate coffee using at least the water.

22. The system of claim 1, further comprising a power source configured to provide power to one or both of the dehumidifier or the fluid filter, wherein the power source comprises one or more of: a solar panel, a crank, a battery, or a turbine.

23. A method for generating water from atmospheric conditions, comprising:
(a) filtering air via an air filter, thereby generating filtered air;
(b) heating the filtered air via a first portion of a rotating desiccant core, thereby generating heated air;
(c) generating a moist air stream from the heated air via a second portion of the rotating desiccant core;
(d) condensing the moist air stream with one or more condensers; and
(e) collecting water from the one or more condensers in a first collection tank.

24. The method of claim 23, further comprising filtering the water, via a water filter, collected from the one or more condensers at (e).

25. The method of claim 24, further comprising collecting the water in a pitcher after filtering the water.

26. The method of claim 25, further comprising monitoring a water level or a water amount of the water within one or both of the first collection tank or the pitcher.

27. The method of claim 26, further comprising:
storing operation data, wherein the operation data comprises one or more of: a volume of the water collected, a total operation time for collecting the water, a temperature of the air, or a humidity of the air; and
transmitting the operation data to a wireless controller.

28. The method of claim 27, further comprising generating one or more alerts based on the operation data, wherein the one or more alerts correspond to one or more of: an indication to replace a water filter, an indication to replace the air filter, a system malfunction, a low water level or water amount of the water within one or both of the first collection tank or the pitcher, or a high water level or water amount of the water within one or both of the first collection tank or the pitcher.

29. A device for atmospheric water generation comprising:
(A) a housing comprising:
(i) an air filter,
(ii) a dehumidifier comprising a desiccant core in fluid connection with the air filter, a heater in thermal connection with the desiccant core, and a condenser in fluid connection with the desiccant core,
(iii) a water filter in fluid connection with the condenser,
(iv) a water outflow conduit in fluid connection with the water filter, and
(v) a pitcher cavity; and
(B) a pitcher physically removable from the pitcher cavity and in fluid connection with the water outflow conduit.
